(19) United States
(12) Patent Application Publication
(10) Pub. No.: US 2026/0368980 A1
(43) Pub. Date: Nov. 19, 2026

(54) System and Method for Task Agnostic Realization Agnostic Animation

(71) Applicant: Openstream Inc., Bridgewater, NJ (US)

(72) Inventors: Laxmi Narayen Nagarajan Venkatesan, Chennai (IN); Divyam Choudhary, Mumbai (IN); Sai Madhavan Ganesan, Chennai (IN); Subhajeet Lahiri, Jamshedpur (IN); Dinesh Babu Jayagopi, Bengaluru (IN); Rajasekhar Tumuluri, Bridgewater, NJ (US); Magnus Revang, Voyenenga (NO)

(73) Assignee: Openstream Inc., Bridgewater, NJ (US)

(21) Appl. No.: 19/681,331

(22) Filed: May 19, 2026

Related U.S. Application Data
(60) Provisional application No. 63/808,156, filed on May 19, 2025.

(51) Int. Cl. G06T 13/00; G06N 3/0455; G06N 3/094; G10L 15/25

(52) U.S. Cl. CPC G06T 13/00; G06N 3/0455; G06N 3/094; G10L 15/25

(57) ABSTRACT

A system and method for task agnostic realization agnostic animation. A two-stage, identity-preserving, task-agnostic, realization-agnostic framework is described for audio driven talking face generation and reenactment tasks. The framework disentangles audio-to-landmark generation and landmark-to-image synthesis tasks by operating on facial landmarks as an intermediate representation. The modular design facilitates robust identity preservation, headpose control, and consistency across tasks and realizations.

### CROSS-REFERENCE

This application claims priority to and the benefit of U.S. Provisional Patent Application No. 63/808,156, filed May 19, 2025, the entire disclosure of which is incorporated by reference herein.

### BACKGROUND

Animating an expressive talking head is a long-standing cross-modal task in computer graphics and vision with several real-world applications, including the generation of digital humans, movie production, video conferencing, visual chatbots, digital marketing being a few. Animation technologies are becoming more realistic by employing complex methods that resemble human anatomy-inspired movement logic to using diffusion models. While complex 3D methods focus on realism regarding realistic facial expressions, they restrict themselves to their own specific 3D asset space. The 2D video generation methods prioritize the generation quality in terms of the resolution of the frames. Training a model as complex as diffusion comes with its own requirements, such as a very large dataset for training and high-performance GPUs to accommodate them. This makes the usage of such models expensive.

The current state-of-the-art methods tend to focus on solving a single task-specific mode of realization, where the tasks are defined by the modalities guiding the generation across realization domains (2D and 3D). A viable alternative would be to use a reliable, computationally lighter GAN (Generative Adversarial Networks) variants for each task, with a good focus on lip sync but compromising a little on the visual quality and later using models super-resolution and face enhancement methods like to increase the resolution. But, looking at other tangible assets involved in commercial applications of an embodied agent, a separate model, even a GAN-variant for each task, would make each realization inconsistent and incoherent. Carrying out diffusion variants would be comparatively difficult and costlier and not even close to real-time. As more and more applications are defined based on different modality-driving the generation, having a unified framework with consistent performance across all tasks would be ideal.

### SUMMARY

Described herein are systems and methods for task agnostic realization agnostic animation. In implementations, a system for audio-driven facial animation that is task-agnostic and domain-agnostic includes a processing pipeline including an audio-to-landmark generation module and from a landmark to-animation synthesis module, where the audio-to-landmark generation module and the landmark to-animation synthesis module are decoupled to allow independent utilization of intermediate outputs for different animation tasks, the audio-to-landmark generation module is configured to receive an audio input and generate a sequence of facial landmarks that encode temporally coherent facial expressions, wherein the facial landmarks are independent of identity and adaptable to both 2D and 3D animation domains, the landmark-to-animation synthesis module is configured to generate animations for a target face from the generated facial landmarks, wherein the landmark-to-animation synthesis module supports both 2D and 3D representations by dynamically adapting to a target animation domain, a head pose adaptation mechanism configured to procedurally generate head movements from the audio input or transfer head pose dynamics from a reference video, and a training architecture, wherein a single model is trained on a dataset to generate a trained model and wherein the trained model is reuseable across the different animation tasks without architectural modifications, where the processing pipeline enables editing of the generated facial expressions generated from the audio input in a landmark space.

### BRIEF DESCRIPTION OF DRAWINGS

The various embodiments of the disclosure will hereinafter be described in conjunction with the appended drawings, provided to illustrate, and not to limit, the disclosure, wherein like designations denote like elements, and in which:

FIG. 1 is a block diagram of an example of a task-agnostic and realization agnostic, unified architecture in accordance with the embodiments of this disclosure.

FIG. 2A and FIG. 2B are block diagrams of a first stage of the task-agnostic and realization agnostic, unified architecture in accordance with embodiments of this disclosure.

FIG. 3 is a block diagram of a rotation auto encoder used for training an instance of a rotator decoder in a first stage of the task-agnostic and realization agnostic, unified architecture in accordance with embodiments of this disclosure.

FIG. 4 is a block diagram of a second stage of the task-agnostic and realization agnostic, unified architecture in accordance with embodiments of this disclosure.

FIG. 5 is a qualitative comparison showing spoken lip visemes across audio-driven 3D models in accordance with embodiments of this disclosure.

FIG. 6 is an image showing landmark sketches with and without torso, saying “helps” in accordance with embodiments of this disclosure.

FIG. 7 is a comparison of different face reenactment methods.

FIG. 8 is a quantitative evaluation results comparing TARAA with other SOTA models for the task of Talking Portraits.

FIG. 9 is a quantitative evaluation results comparing TARAA with other SOTA models for visual face dubbing.

FIG. 10 is a Human Perceptual Evaluation across Face Reenactment, Visual Face Dubbing, Talking Portraits, and 3D Model Metrics.

FIG. 11 is a comparison of landmark reconstruction error between LSTM and Transformer-based method for the Audio2Pixel pipeline.

FIG. 12 is a block diagram of an example of a computing device and/or computer system in accordance with the embodiments of this disclosure.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU) s, one or more graphics processing units (GPU) s, one or more digital signal processors (DSP) s, one or more application specific integrated circuits (ASIC) s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Audio-driven facial expression and head movement generation has succeeded in synthesizing talking faces with accurate lip synchronization. However, incorporating temporally coherent facial expressions, robust head pose control, and preserving identity remains a significant challenge. Moreover, task-specific methods often lack the flexibility to generalize across tasks, such as face reenactment, talking portrait synthesis, and visual face dubbing. Furthermore, current models do not generate outputs across different realizations (i.e., 2D and 3D).

Described herein is a two-stage, identity-preserving, task-agnostic, realization-agnostic architecture (TARAA) or framework for audio driven talking face generation and reenactment tasks. The framework disentangles audio-to-landmark generation and landmark-to-image synthesis tasks by operating on facial landmarks as an intermediate representation. This modular design facilitates robust identity preservation, head pose control, and consistency across tasks and realizations. Evaluations demonstrate that the method is better or on par with the state-of-the-art methods in quantitative evaluations, qualitative, and human perceptual studies across different tasks and realizations, proving the method's effectiveness.

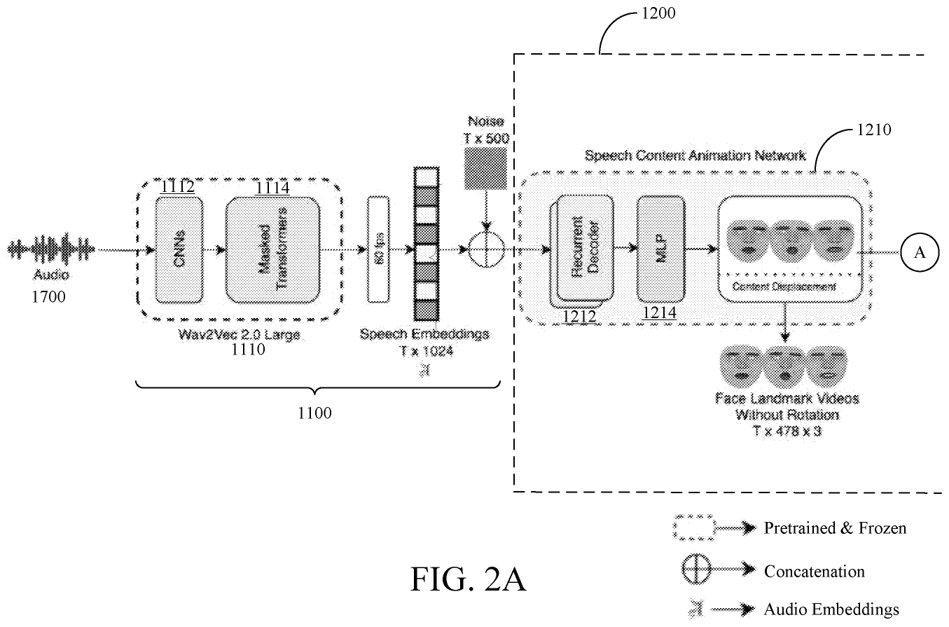

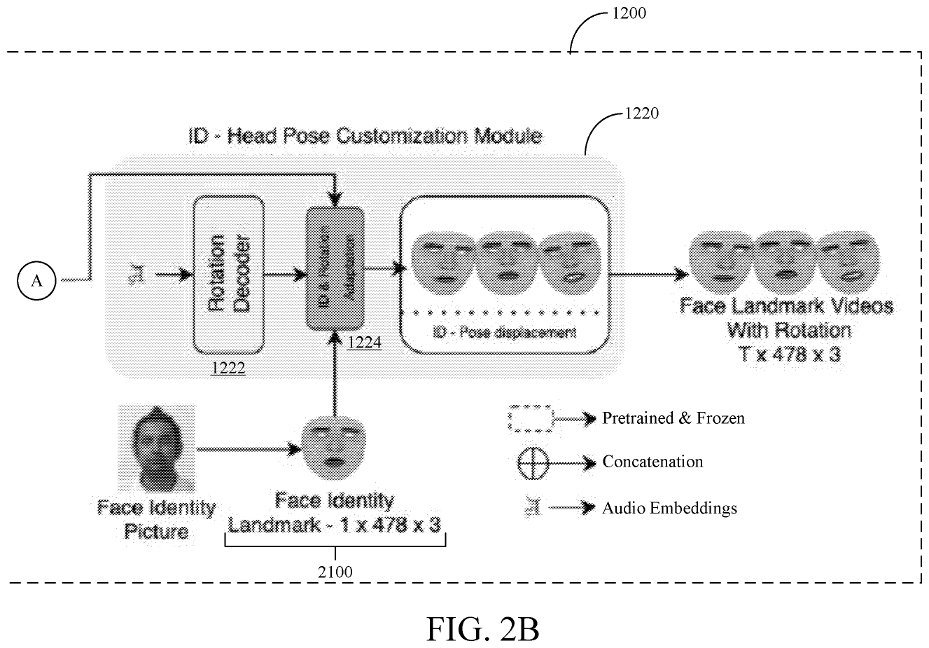

An intermediate representation is critical to achieving a task-agnostic and realization domain-agnostic facial animation system. 3D facial landmarks are used as an intermediate representation due to their unique advantages in preserving the person's structural identity and flexibility across different animation tasks and realizations. As landmarks naturally encapsulate essential motion information, they enable a unified processing pipeline that can be conditioned on multiple tasks without requiring architectural modifications. Stage 1 of the architecture, Audio2Mesh (as shown in FIG. 2A and FIG. 2B), learns to produce meaningful full facial landmark deformations driven by the audio. The generated landmarks are already vertices in the 3D space, ready to be consumed by 3D avatars.

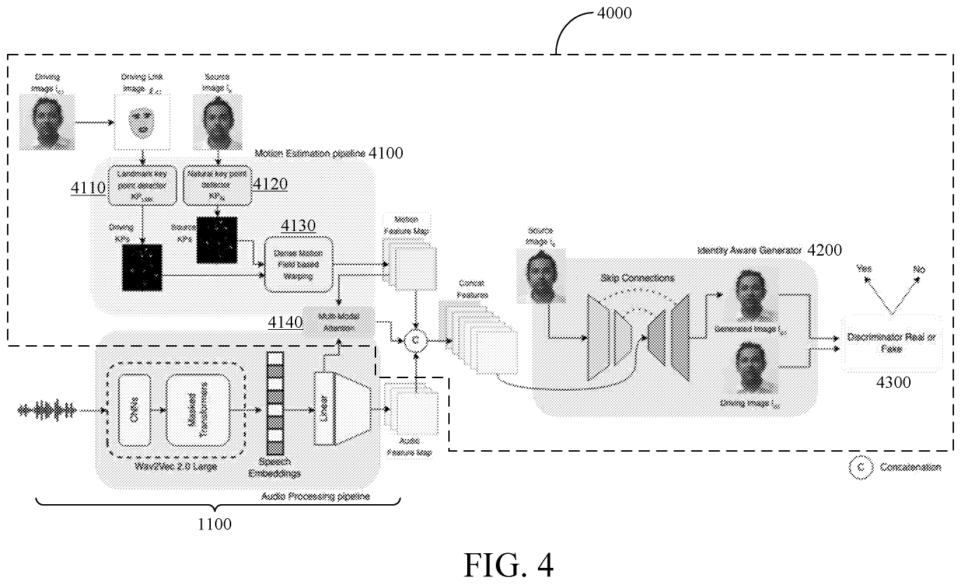

Landmarks capture identity information as geometric and structural information via specific key points detected on the face (e.g., eyes, nose, mouth, jawline). However, the natural image of a face contains rich visual information such as skin texture, pores, freckles, wrinkles, scars, blemishes, skin color, tone, and other natural features. This could be a challenge in facial animation via landmarks, as it requires preserving natural facial identity while using only geometric and structural information. This is overcome via the stage 2 architecture, Mesh2Pixel (as shown in FIG. 4), which formulates the problem as a conditioned image-to-image translation task that learns the mapping between geometric and structurally rich landmarks and natural images. This way, by leveraging facial landmarks as the intermediate representations, the Audio2Mesh module can generate temporally coherent, geometric, and structural identity-preserving facial motion that can seamlessly translate across 2D via the Mesh2Pixel pipeline and 3D bones of the rigged mesh via animation transfer.

TARAA can solve the problem of multimodal guided facial expression synthesis. In implementations, the framework decouples audio-to-landmark (Audio2Mesh) generation from landmark-to-video (Mesh2Pixel) synthesis. The modular architecture enables easy integration, customization, and independent utilization of intermediate outputs for different applications allowing outputs of the Audio2Mesh pipeline to be consumed directly by rigged 3D avatars or take it to the Mesh2Pixel pipeline for 2D Task-agnostic design that unifies facial animation tasks of face reenactment, visual face-dubbing, and within a single framework. The head rotation decoder from the Audio2Mesh module supports the direct generation of head poses from audio. Otherwise, head poses from reference videos can also be adapted for the generation, allowing flexibility in head pose control. This enables personalized and application specific outputs tailored to user-defined requirements in both 2D and 3D spaces.

The modalities used to guide the generation process greatly influence expressive talking heads. These methods can be broadly classified into audio and video-driven expressive talking heads.

Video-guided face generation focuses on creating realistic face animations by maintaining the identity of a still image while transferring motion from a driving video we call face reenactment. The first-order motion model is a seminal work that introduced key point-based animation via self-supervised learning and local affine transformations for the face reenactment task. These works are based on using multiple key point sets with thin-plate spline transformations for improved warping and by incorporating depth information to reduce artefacts, respectively. While these methods provide good face reenactment, they suffer from artefacts like reduced lip sync transfer and wobbly head motion when the face structure and pose in driving videos and target images differ. Many methods employ 3D priors for structure-aware face retargeting or detailed 3D reconstruction to better preserve identity in face reenactment, yet adapting these techniques for other tasks like visual face dubbing or talking portraits is non-trivial.

GAN-based methods, employing latent space transformations, spatial-style decomposition, prior face understanding, and AU encoding, produce good face reenactment results. Known audio-visual approaches take input audio, pose reference, or emotional source video and a single image to synthesize talking faces. Yet they cannot be used directly to perform other tasks. Landmark-based approaches blend explicit and implicit modelling with other techniques using landmark transformers to separate expression geometry from identity.

Audio-driven talking head synthesis creates dynamic facial animations from audio inputs. Most recent methods in Talking Portraits employ diffusion models. The 2D diffusion models mostly prioritize the generation quality in terms of the resolution of the frames. Diffusion methods in 3D realization domains focus on realistic facial expressions, but they restrict themselves to their own specific 3D asset space.

Training a diffusion model requires a large dataset and high performance GPUs to accommodate it, making it expensive. Nerf-based and Gaussian Splatting based methods offer photorealistic audio driven face synthesis, some even in real-time. But unlike general one-shot methods, these are confined to a single person in a few-shot setting, and their reliance on predefined head poses limits expressiveness.

Another technique combines the self-attention mechanism with Bi-LSTM to predict the landmark displacement from audio. Later methods employed image-audio conditioned GANs for expressive facial animations in both talking portraits and visual face dubbing, with Wav2Lip excelling in visual face dubbing. IPLAP combined dense motion, generated lip landmarks, and audio to condition generation; however, as both IPLAP and Wav2Lip are inpainting-based, they exhibit artifacts when the original video is speaking while the dubbed audio is silenced. Diff2Lip, which employs a diffusion with an inpainting approach for visual face dubbing, addresses this issue to some extent by generating a complete bottom half of the face, though some artifacts persist.

In the talking portraits task, Audio2Head generates head poses from audio and uses dense motion-based reconstruction techniques to render images, achieving holistic head motion at the expense of identity preservation. In contrast, VAE-based models capture stochastic motion variations for expressive and natural head movements, making them suitable for both tasks despite inconsistencies in long-duration outputs and lower generative quality compared to GANs. Other works cross-over landmarks with either GANs or diffusion in an attempt to integrate both synchronized-lip shapes and the image quality for talking portraits and visual dubbing tasks showing the potential of the landmark space.

TARAA decouples audio-to-landmark generation from landmark-to-video synthesis while introducing task- and realization domain-agnosticism in talking head tasks. First, the Audio2Mesh module generates distinct 3D facial landmarks from input audio, which can be directly applied to a rigged 3D avatar. By integrating the Mesh2Pixel module, this also enables 2D face reenactment, visual face dubbing, and talking portraits. The Mesh2Pixel model is built on the principle of FOMM, as described in Aliaksandr Siarohin, Stephane Lathuili’ ere, Sergey Tulyakov,’ Elisa Ricci, and Nicu Sebe, “First order motion model for image animation”, Advances in neural information processing systems, 32, 2019, which is incorporated herein in its entirety as if set forth herein, generates the complete face leading to lesser audio-visual artifacts in visual face dubbing and talking portrait tasks. While the audio-video attention logic is inspired by AVFR-GAN, Madhav Agarwal, Rudrabha Mukhopadhyay, Vinay P. Namboodiri, and C. V. Jawahar, “Audio-visual face reenactment”, In Proceedings of the IEEE/CVF Winter Conference on Applications of Computer Vision (WACV), pages 5178-5187, 2023, which is incorporated herein in its entirety as if set forth herein. The present technique treats audio as discrete embeddings and computes Audio-Visual attention as a one-on-one mapping between audio and video embeddings rather than treating them as a continuous feature. In contrast with FOMM, the described technique uses 2 key point detectors (see FIG. 4), one for natural images and one for landmark sketches, where the main guidance is via the landmarks themselves. This framework is the first to unify multiple facial animation tasks across both 2D and 3D domains within a single, generalizable system.

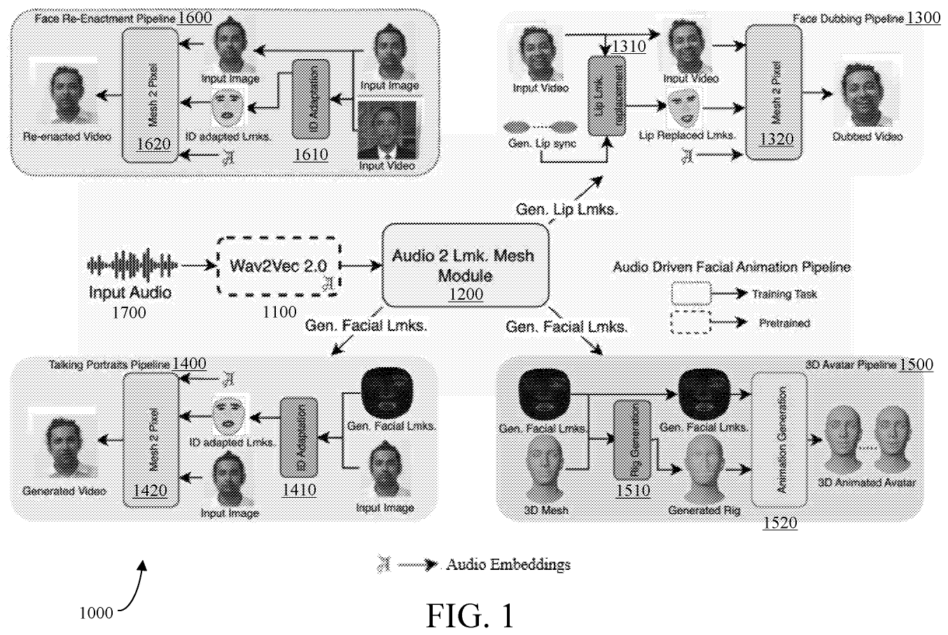

FIG. 1 is a block diagram of an example of a task-agnostic and realization agnostic, unified architecture (TARAA) or framework 1000 in accordance with the embodiments of this disclosure. The framework 1000 solves multiple 2D tasks like face-reenactment, visual face dubbing, talking portraits, and 3D Talking heads defined by audio or video driving modalities. The framework 1000 uses landmarks as intermediate representations. The framework 1000 works well even for source images with extreme rotations and creates coherent outputs. For a given audio sequence A=[α₁, α₂, . . . , α_{T}] ∈R^{T×d}, where T represents the number of audio frames and d represents the feature dimension, the method or framework 1000 generates 2D talking videos and 3D talking avatars. The framework 1000 enables cross-task generalization.

The framework 1000 can include, but is not limited to, an audio processing pipeline 1100, a first stage or an audio2mesh engine 1200 (i.e., an audio-to-landmark generation module), and multiple animation engines. The multiple animation engines can include, but are not limited to, a face dubbing pipeline 1300, a talking portraits pipeline 1400, a 3D avatar pipeline 1500, and a face reenactment pipeline 1600. The number of components shown herein are illustrative and there may be more or less in the framework 1000. The framework 1000 and the components therein may include other elements which may be desirable or necessary to implement the devices, systems, and methods described herein. However, because such elements and steps do not facilitate a better understanding of the disclosed embodiments, a discussion of such elements and steps may not be provided herein.

The audio processing pipeline 1100 is configured to extract and encode speech-related features (e.g., phonetic and prosodic information) from an input audio 1700. Separation of the audio processing pipeline 1100 improves clarity by distinguishing audio feature extraction from subsequent modules or processing that generate and refine facial landmarks. The delineation is consistent with the modular design of the framework 1000, in which the audio processing pipeline 1100 serves as an independent upstream component feeding into the motion generation and animation pipelines including, but not limited to, a stage 2 or mesh2pixel pipeline (i.e., a landmark-to-animation synthesis module), the audio2mesh engine 1200, the face dubbing pipeline 1300, the talking portraits pipeline 1400, the 3D avatar pipeline 1500, and the face reenactment pipeline 1600. The audio processing pipeline 1100 is configured to output audio embeddings.

In certain implementations, audio2mesh engine 1200 and associated landmark generation framework are trained using synchronized audio and facial landmark datasets (i.e., training dataset) to learn generalized speech-driven facial motion representations independent of downstream animation tasks. As the facial landmarks are used as a shared intermediate representation, the trained model (the audio2mesh engine 1200 and associated landmark generation framework) can be reused or is reusable across multiple animation tasks (e.g., face dubbing, talking portraits, and face reenactment) and across both 2D and 3D domains without requiring task-specific architectural modifications. The training dataset may include synchronized audio, facial landmarks, head-pose information, and augmented pose variations to improve generalization across identities, viewpoints, animation domains, and diverse camera angles. In certain implementations, the training dataset can further include multiple speakers, poses, and expression variations. The training dataset are curated for training and benchmarking the system.

The audio2mesh engine 1200 is configured to generate a unified set of facial landmarks as an intermediate representation. The facial landmarks capture identity information as geometric and structural information via specific key points detected on the face (e.g., eyes, nose, mouth, jawline). The unified set of facial landmarks can include lip landmarks as a subset. As described herein, each of the multiple animation engines can use a relevant portion of the unified set of facial landmarks depending on the specific task performed by the animation engine (e.g., lip-focused dubbing vs. full-face animation). The facial landmarks act as a bridge between 2D and 3D representations, enabling the same generated landmark motion sequences to drive both a 2D talking-head synthesis pipeline and a 3D mesh-based avatar animation pipeline. The facial landmarks provide a unified representation that is compatible with both mesh-based 3D animation and image-based 2D animation.

The face dubbing pipeline 1300 is configured to use the generated lip-synchronized landmarks from the audio2mesh engine 1200 to output dubbed video. The face dubbing pipeline 1300 can include, but is not limited to, a lip landmark replacement module 1310 and a mesh2pixel pipeline 1320. The lip landmark replacement module 1310 uses the generated lip-synchronized landmarks and an input video to generate lip replaced landmarks. The mesh2pixel pipeline 1320 uses the input video, the lip replaced landmarks, and the audio embeddings from the audio2mesh engine 1200 to generate the dubbed video.

The talking portraits pipeline 1400 is configured to use the generated full facial landmarks from the audio2mesh engine 1200 to output generated video. The talking portraits pipeline 1400 can include, but is not limited to, an identity adaptation module 1410 and a mesh2pixel pipeline 1420. The identity adaptation module 1410 uses the generated full facial landmarks and an input image to output identity adapted landmarks. The identity adaptation module 1410 refines the generated full facial landmarks to align with the geometric structure and identity-specific characteristics of the input face image. Specifically, the identity adaptation module 1410 adapts generic audio-driven facial motions to the target identity by incorporating facial shape, proportions, and structural attributes extracted from the input image, thereby ensuring identity consistency (identity-consistent) in the generated talking-head video.

The mesh2pixel pipeline 1420 uses the input image, the identity adapted landmarks, and the audio embeddings from the audio2mesh engine 1200 to output the generated video.

The 3D avatar pipeline 1500 is configured to use the generated full facial landmarks from the audio2mesh engine 1200 to output a 3D animated avatar. The 3D avatar pipeline 1500 can include, but is not limited to, a rig generation module 1510 and an animation generation module 1520. The rig generation module 1510 uses the generated full facial landmarks and a 3D mesh. The rig generation module 1510 generates a controllable facial rig for the input 3D mesh based on the generated full facial landmarks. The rig generation module 1510 establishes correspondences between landmark positions and deformable regions or control points of the 3D mesh, enabling the mesh to be animated according to the predicted facial motions while preserving the structural characteristics of the avatar. The animation generation module 1520 uses the generated full facial landmarks and the generated rig to output the 3D animated avatar. The animation generation module 1520 applies the generated full facial landmarks to the generated rig to produce temporally coherent 3D facial animations. That is, the animation generation module 1520 drives deformation of the rigged 3D mesh using the landmark motion sequences, thereby generating a lip-synchronized and expression-consistent 3D animated avatar.

As noted, the rig generation module 1510 adapts the generated landmark motion representations to the structural and deformation characteristics of the target 3D mesh, while the animation generation module 1520 applies the adapted landmark-driven motion to the rigged mesh to generate the final 3D animated avatar. The cooperative operation and functionality of the rig generation module 1510 and the animation generation module 1520 in the 3D avatar pipeline 1500 can be referred to as a domain adaptation module or engine, which enables cross-domain transfer by mapping 2D landmark motion sequences to 3D mesh-based deformations.

The face reenactment pipeline 1600 is configured to use the generated full facial landmarks from the audio2mesh engine 1200 to output re-enacted video. The face reenactment pipeline 1600 can include, but is not limited to, an identity adaptation module 1610 and a mesh2pixel pipeline 1620. The identity adaptation module 1610 uses the generated full facial landmarks, a target input image, and input video to output identity adapted landmarks. The identity adaptation module 1610 refines the generated full facial landmarks to align with the facial geometry, structural attributes, and identity-specific characteristics of the target input image. The identity adaptation module 1610 adapts the audio-driven facial motions and expressions extracted from the input video to the target identity, enabling realistic transfer of facial expressions and motion while preserving the appearance and structural consistency of the target face. The mesh2pixel pipeline 1620 uses the target input image, the identity adapted landmarks, and the audio embeddings from the audio2mesh engine 1200 to output the re-enacted video. In implementations, the face reenactment pipeline 1600 can use intermediate modules such as a speech-content animation module and/or an identity/head-pose customization modules to refine inputs into the mesh2pixel pipeline 1620. The face reenactment pipeline 1600 uses the generated full facial landmarks along with the target identity input (i.e., the target input image or target face), to transfer expressions and motion onto the target face while preserving identity-specific characteristics. Thus, similar to the other animation pipelines (e.g., the face dubbing pipeline 1300 and the talking portraits pipeline 1400), the face reenactment pipeline 1600 represents a task-specific realization within the framework 1000, demonstrating how the shared intermediate representation can be leveraged for different animation tasks.

The identity adaptation module 1410 and the identity adaptation module 1610 are functionally related modules used in different task-specific pipelines within the framework 1000. In certain embodiments, the identity adaptation module 1410 and the identity adaptation module 1610 may share the same or substantially similar underlying architecture for adapting generated facial landmarks to a target identity. However, the identity adaptation module 1610 in the face reenactment pipeline 1600 additionally incorporates motion and/or expression information derived from an input video to enable expression transfer onto the target identity, whereas the identity adaptation module 1410 in the talking portraits pipeline 1400 primarily adapts audio-driven facial motion to a target identity image.

FIGS. 2A and 2B are block diagrams of an audio2mesh engine 1200 in accordance with embodiments of this disclosure. The audio2mesh engine 1200 receives audio embeddings from the audio processing pipeline 1100.

The audio processing pipeline 1100 can include, but is not limited to, a Wav2Vec2.0 large model 1110. The Wav2Vec2.0 large model 1110 can include, but is not limited to, a CNN(s) 1112 and masked transformers 1114. A given audio is converted into a sequence of token vectors using Wav2vec 2.0 for predicting the intermediate predictions of the 3D landmark displacements. A given audio is converted into a sequence of token vectors using the Wav2Vec2.0 large model 1110, which is described in Alexei Baevski, Yuhao Zhou, Abdelrahman Mohamed, and Michael Auli, “wav2vec 2.0: A framework for self-supervised learning of speech representations”, Advances in neural information processing systems, 33:12449-12460, 2020, which is incorporated herein in its entirety as if set forth herein, producing embeddings:

A=[a₁,a₂, . . . ,a_{T}]∈R^{T×d}, (2)

where Tis the number of audio frames and dis the embedding dimensionality from Wav2Vec2.0. We use an embedding dimension d of 1024, which uses the Wav2Vec2.0 large model 1110. The sequence of token vectors are processed at 60 frames per second to generate speech or audio embeddings. The speech or audio embeddings are concatenated with noise.

The audio2mesh engine 1200 can include, but is not limited to, a Speech Content Animation Network (SCAN 1210) and an identity-head pose customization module 1220. The SCAN 1210 generates lip sync. That is, the SCAN 1210 maps the speech or audio content to landmark displacements synchronizing the lip, jaw and other nearby regions with the input speech. In implementations, the outputs can be consumed directly from this stage for general lip-syncing only tasks. The identity-head pose customization module 1220 adds rotations and adapts to the source image identity. The identity-head pose customization module 1220 modulates the landmark displacements from the SCAN 1210 by accounting for the face identity landmarks and the head pose that are either procedurally transferred and/or predicted from audio. The SCAN 1210 provides variability in facial expressions based on speech content, ensuring that emotional and linguistic cues are reflected in the generated animations.

The decoupling of lip sync generation and pose/ID adaptation simplifies and modularizes the solution formulation. In this stage, the audio2mesh engine 1200 aims to generate 3D facial landmarks \hat{L}ₜ:

$${\{ {\hat{L}}_{t} ∈ {ℝ}^{478 \times 3} \}}_{i = 1}^{T} , \qquad ( 1 )$$

The SCAN 1210 can include, but is not limited to, a recurrent decoder 1212 (which can be a deep learning-based recurrent decoder model (encoder-decoder)) and a Multi-Layer Perceptron (MLP) (MLP 1214). The MLP 1214 is a neural network. The MLP 1214 processes the intermediate features generated by the recurrent decoder 1212 and maps the features into corresponding facial landmark coordinates. The MLP 1214 transforms the temporally encoded audio representations into spatial landmark predictions, which enables the generation of lip-synchronized facial landmark sequences corresponding to the input speech. The SCAN 1210 is where the audio inputs are transformed into animated facial landmarks. The extracted embeddings i.e., Wav2Vec2.0 embeddings of shape T×1024, are used to generate lip sync in the landmarks. We try to use simpler architectures to solve this problem, like LSTM, as described in Sepp Hochreiter and J″urgen Schmidhuber, “Long short-term memory”, Neural computation, 9(8): 1735-1780, 1997, which is incorporated herein in its entirety as if set forth herein. To simplify the learning by the network, we completely remove any head-pose information and normalize the identity to a reference ID. The reference ID refers to a normalized canonical facial identity representation used during training to remove identity-specific variations from the landmark data. This normalization enables the SCAN 1210 to focus primarily on learning speech-driven lip synchronization independent of facial identity (identity-independent) and head pose variations. In certain embodiments, the reference ID may correspond to a predefined neutral facial landmark template or canonical face geometry used as a common reference space during training. We limit the learning of the model in this stage to just learning Lip Sync from audio. To introduce variability, a noise vector N of shape:

N^{∈}R_{T×500}, (3)

is concatenated with the audio embeddings:

A′=Concat(A,N)∈R^{T×1524} (4)

Given the audio and noise concatenated vector our recurrent decoder ƒ_{recurr}:

\hat{L}_{content,t}=ƒ_{recurr}(A′)∈R^{T×478×3}, (5)

where \hat{L}_{content} represents the content displaced landmarks for T frames.

The objective loss function used for training the SCAN 1210 focuses on minimizing the difference between the predicted landmarks and the ground truth. We employ a combination of L1 loss (Mean Absolute Error) and Mean Squared Error (MSE) loss to ensure both robustness and smoothness in the generated facial landmarks.

Restating, the extracted audio embeddings (e.g., Wav2Vec2.0 embeddings) are processed by the recurrent decoder 1212 and MLP 1214 to generate animated facial landmarks from the audio input. The SCAN 1210 learns speech-driven facial motion representations using deep learning-based audio features while focusing on lip synchronization independent of identity and head pose. Temporally varying facial landmark sequences are derived from the deep audio embeddings and speech-content-aware representations within the SCAN 1210. That is, the deep learning-based audio embeddings are processed by the recurrent decoder 1212 and MLP 1214 to generate temporally varying facial landmark sequences from the audio input. As stated above, the SCAN 1210 maps the audio content to landmark displacements to synchronize facial regions with speech, while the identity-head pose customization module 1220 modulates these landmark displacements using identity and head-pose information. Additionally, as described herein, a multi-modal attention mechanism 4140 dynamically modulates motion feature maps using audio-driven motion features and identity-specific priors to achieve natural speech-driven movement and subject-specific expressiveness. Collectively, the recurrent decoder 1212, the MLP 1214, the SCAN 1210, and the multi-modal attention mechanism 4140 enable modulation of facial animations using deep learning features extracted from the audio input, enabling natural expression variations beyond basic lip synchronization.

The identity-head pose customization module 1220 can include, but is not limited to, a rotation decoder 1222 and an identity and rotation adaptation module 1224. The identity-head pose customization module 1220 takes in the source image (face identity picture) and the rotation matrices (either a video for rotation transfer and/or audio for rotation generation). The identity-head pose customization module 1220 transforms the content-displaced landmarks into ID-Pose displaced landmarks. These ID-Pose displaced landmarks will have head rotations synced with audio and ID, the same as that of the face identity source image in the landmark space. The identity and rotation adaptation module 1224 refines and/or edits the generated facial landmarks by incorporating identity-specific characteristics and head pose (rotation) information. In certain embodiments, the identity and rotation adaptation module 1224 can use a recurrent neural network, transformer-based architecture, or similar temporal modeling approach to predict and adapt natural head movements based on speech characteristics such as intonation and temporal dynamics. The geometric and rotation-based landmark transformations can be referred to as stable first principles-based transformations, which are used to adapt facial motion to identity-specific facial structures and pose configurations/adjustments within the identity and rotation adaptation module 1224, while maintaining temporal consistency.

The identity-head pose customization module 1220 solves the problem of identity transformation in the landmark space by using non-learning methods that employ geometric transformations and translations. We exploit the simplicity of the landmarks to formulate this as a Geometric Transformation problem. Examples of such transformations can be seen in FIG. 1, where the generated landmarks are ID transformed into landmark sketches. For example, in the talking portraits pipeline 1400 and the face reenactment pipeline 1600.

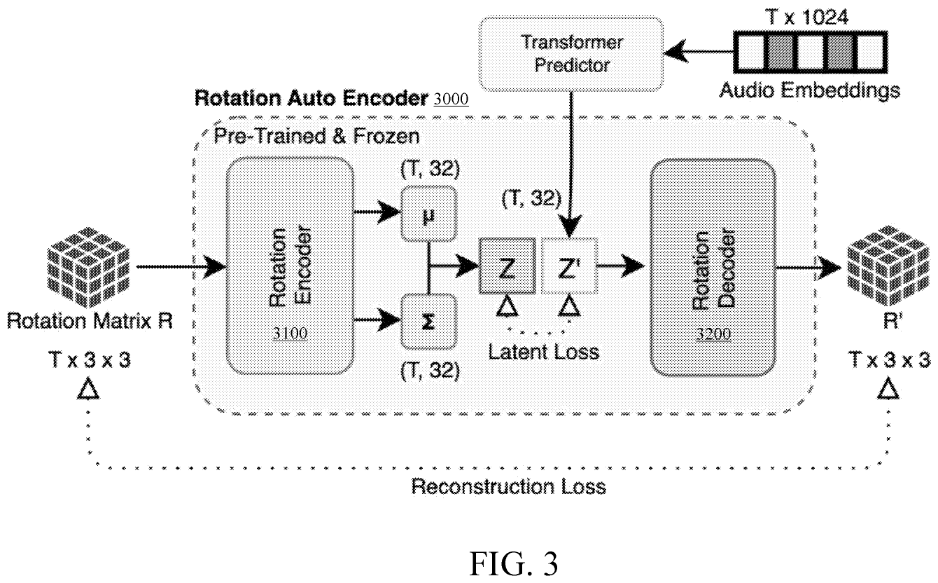

FIG. 3 is a block diagram of a rotation autoencoder 3000 in the first stage of the task-agnostic and realization agnostic, unified architecture in accordance with embodiments of this disclosure. The rotation autoencoder 3000 is a VAE model that is, in the first stage, trained to learn the structure of rotations via reconstruction and then in the second stage, learn the mapping between the audio embeddings and the latent space. The rotation autoencoder 3000 includes a rotation encoder 3100 and rotation decoder 3200. The rotation encoder 3100 generates a latent representation of the rotation, and the rotation decoder 3200 operates on this latent representation to reconstruct or generate the corresponding rotation parameters. Thus, the rotation decoder 3200 output represents the final output of the rotation autoencoder 3000.

The rotation autoencoder 3000 includes an internal encoder-decoder structure used during training to learn a compact latent representation of head pose (rotation). The decoder within the rotation autoencoder is primarily used to reconstruct rotation parameters from the latent space as part of the autoencoder training objective. The rotation decoder 1222 referenced in FIG. 2B is functionally derived from, or corresponds to, the decoder component of the trained rotation autoencoder 3000. During inference, only the decoder portion is used to map latent rotation representations into explicit rotation parameters. Thus, the rotation decoder 1222 is not a separate independently trained module, but rather the deployed instance (or reuse) of the decoder learned within the rotation autoencoder 3000. In certain embodiments, the rotation decoder 1222 may be implemented as a distinct module initialized from the trained autoencoder decoder and optionally fine-tuned for downstream animation tasks.

As shown in FIG. 2A and FIG. 2B, the SCAN 1210 generates forward-facing landmarks without rotations. To predict rotation matrices, we use a two-stage design. The rotation autoencoder 3000 learns a rotation prior using a Variational Auto-Encoder (VAE) (described in Diederik P Kingma, MaxWelling, et al, “Auto-encoding variational bayes” 2013, which is incorporated herein in its entirety as if set forth herein. Given rotation matrix R∈R^{T×3×3}, the rotation autoencoder 3000 maps the 3×3 matrix from the rotation encoder 3100, i.e., maps the input into a distribution modeled by the mean and sigma each of which are vectors T×32. These vectors are then converted into a latent embedding Z of shape T×32. The embedding size of 32 is an empirical choice. The rotation decoder 3200 accepts Z′ E R^{T×32} as input and processes it to yield R′ ∈ R^{T×3×3}. In stage 2, we freeze the rotation encoder 3100 and use a 12-layer transformer to project wav2vec embeddings T×1024 into a 32-dimensional latent vector. This vector is then passed through the rotation decoder 3200 to get R′, the predicted rotation matrix. The objective functions we use for matrix reconstruction and latent vector reconstruction are both L1.

The “Face Identity Landmark” (1×478×3) in FIG. 2B is generated from the input Face Identity Picture using a facial landmark extraction module which can be an integrated preprocessing module or standalone preprocessing module (facial landmark extraction module 2100). A pre-processing step applies a landmark detection algorithm or model to the Face Identity Picture to extract a fixed set of identity-specific 3D facial landmarks. These landmarks capture the geometric structure of the target identity and are subsequently provided as input to the identity and rotation adaptation module 1224. The facial landmark extraction module 2100 operates independently of the audio-driven pipeline and serves to initialize identity-specific facial geometry for downstream processing.

FIG. 4 is a block diagram of a second stage or a mesh2pixel 4000 (i.e., a landmark-to-animation synthesis module) of the task-agnostic and realization agnostic, unified architecture in accordance with embodiments of this disclosure. The mesh2pixel 4000 is the mesh2pixel pipeline 1320, the mesh2pixel pipeline 1420, and/or the mesh2pixel pipeline 1620. The mesh2pixel 4000 generates animations for a target face from the generated facial landmarks. The mesh2pixel 4000 supports both 2D and 3D representations by dynamically adapting to a target animation domain. The generated animations are conditioned on user defined parameters such as speaking style intensity, eyeblink rate, or linguistic context. The conditioning on user-defined parameters can be performed within one or more downstream refinement or synthesis modules, such as the SCAN 1210, the identity and rotation adaptation module 1224, and/or in the mesh2pixel pipeline. These components can modify generated facial landmarks or synthesized outputs based on controllable parameters such as speaking style intensity, eye-blink frequency, emotional intensity, or linguistic context to produce customized animation behavior.

The mesh2pixel 4000 can include, but is not limited to, a motion estimation module 4100 or motion estimation pipeline and an identity aware generator 4200. The motion estimation module 4100 can include, but is not limited to, a landmark key point detector 4110 and a natural key point detector 4120. The mesh2pixel 4000 uses a source image and a driving landmark image to extract key points. The natural key point detector 4120 is configured to extract source key points from the source image. The landmark key point detector 4110 is configured to extract driving key points from the driving landmark image. The source key points and the driving key points are warped together using a dense motion field warping engine 4130 to generate a dense motion field and corresponding motion feature map. The audio processing pipeline 1100 can extract features from a driving audio to generate an audio feature map, which are used to focus attention on the lip region. The motion feature map and the audio feature map are warped together and passed to the identity aware generator 4200, along with the extracted features of the source image, to produce a final output.

The identity aware generator 4200 maps generated landmarks to 2D images. The identity aware generator 4200 learns to translate between landmark and rich natural images via explicit key-point-based representation. The identity aware generator 4200 uses Generative Adversarial Networks (GANs) to learn this translation and process the inputs frame-by-frame, as GANs may not capture temporal dependencies well.

The motion estimation module 4100 estimates the motion field between a driving frame I_{d,t} and a source frame Iₛ. This motion field is used to compute the motion feature map that captures the transformation required to warp the source frame to match the driving frame. As noted, the motion estimation module 4100 uses the landmark key point detector 4110 and the natural key point detector 4120 to extract the respective key points.

### Key Point Detection

The key point detection stage is integral to the motion estimation module 4100. The landmark key point detector 4110 and the natural key point detector 4120 to generate a robust representation of motion. The landmark key point detector 4110 is used for landmark sketches and the natural key point detector 4120 is used for natural images. The landmark key point detector 4110 and the natural key point detector 4120 extracts from the driving landmark sketches and source natural images L_{d}, respectively, ensuring precise mapping of essential facial features such as the eyes, eyebrows, nose, and the face contour:

$${\{ {X}_{t , n} \}}_{n = 1}^{K} = {M}_{LMK} ( {φ}_{t} ) , t ∈ \{ {L}_{d} \} , \qquad ( 6 )$$

$${\{ {X}_{t , n} \}}_{n = 1}^{K} = {M}_{N} ( {I}_{t} ) , t ∈ \{ s \} , \qquad ( 7 )$$

where [symbol] ₜ is the input landmark frame (driving) and Iₜ is the input source frame ∈ L_{d} which is set of all driving landmark frames at time t (we can also write this [symbol] _{d,t}, and X_{t,n} denotes the detected keypoints X_{t,n} denotes the detected keypoints).

The audio processing pipeline 1100 extracts speech embeddings from Wav2Vec2.0. This is similar to the previously described process. The audio processing pipeline 1100 extracts 1024 dim embeddings from the audio/speech. We then convert the 1024 dimensional to a 256 using a linear layer. An audio encoder in the audio processing pipeline 1100 outputs the audio feature map Enc_{audio} of dimensions

$$\frac{h}{4} \times \frac{w}{4} \times c ,$$

where h, w, and c are the height, width, and channel dimensions, respectively same as the Encₘₒₜᵢₒₙ.

### Multi-Modal Attention

The multi-modal attention mechanism 4140 learns discrete-feature-to-feature implementation between Encₘₒₜᵢₒₙ and the Enc_{audio} which are now wav2vec2.0 embeddings. Where (1,1,256) from a single frame, the corresponding audio frame Enc_{audio} is paired with the motion features at each location:

Encₐₜₜₙ(i,j)=Sigmoid(Enc_{Linear}⊙Encₘₒₜᵢₒₙ(i,j)),

where

$$i ∈ \frac{m}{4} , j ∈ \frac{h}{4} ,$$

Enc_{Linear} represents the 1024 Wav2Vec2.0 features transformed to 256 features, Encₘₒₜᵢₒₙ(i,j) denotes the motion feature map at spatial position (i,j), and ⊙ indicates element-wise multiplication. The multi-modal attention mechanism 4140 dynamically modulates the motion feature map, attending to relevant regions for motion transfer. The multi-modal attention mechanism 4140 adaptively fuses audio-driven motion features with identity-specific priors, ensuring both natural speech-driven movement and subject-specific expressiveness.

The identity aware generator 4200 effectively utilizes both warped features and the source image. Specifically, we concatenate the motion feature map Encₘₒₜᵢₒₙ, the context feature map Enc_{con}, and the attention feature map Encₐₜₜₙ to generate the final warped features, denoted as Enc_{dec}. In addition to feeding Enc_{dec} into the identity aware generator 4200, we separately input the source image Iₛ into a UNet-shaped generator.

The identity aware generator 4200 includes an identity encoder and a decoder. Both employ residual convolutional blocks. The source image Iₛ is first processed through the identity encoder to extract detailed identity features. The encoded identity features are then concatenated with Enc_{dec} and passed through the decoder. I_{gen} is the final output of the generator. This architecture significantly improves the sharpness and realism of the generated outputs compared to existing methods, as demonstrated in our subsequent evaluations. To improve the quality of the generated outputs, we employ a discriminator 4300 (M_{Disc}) in a GAN setup. The discriminator 4300 is optimized to distinguish between real and generated samples.

The motion estimation module 4100, including the landmark key point detector 4110 and natural key point detector 4120, provides spatial motion representations and/or extracts spatial key-point information from source images and driving landmark images to generate dense motion fields and corresponding motion feature maps. The identity aware generator 4200 employs encoder-decoder architectures with residual convolutional blocks to process the spatial motion representations and/or spatial key-point information and motion feature maps. In certain embodiments, the motion estimation module 4100 and the identity aware generator 4200 functionality cooperatively process the spatial motion representations and/or spatial key-point information and motion feature maps to generate temporally coherent facial motion sequences or predict future facial motion sequences, thereby improving animation stability and realism. This can be referred to as a convolution-based model in a motion estimation module implementation. In certain embodiments, the landmark key point detector 4110 and natural key point detector 4120 and/or the dense motion field warping engine 4130 implemented can be convolution-based neural network architectures.

### Evaluation Datasets and Metrics

We evaluate face reenactment on 500 samples of a test set of the VoxCeleb-1 dataset. We take 500, as this is our training task to generate pixels from landmarks. Experiments are performed in two settings, the same ID reenactment and different ID reenactment. In same-id, we use the same person's driving frames to drive the same person's source, while in diff-id reenactment, the source and the driving are from different people. We employ quantitative metrics like L1 Score (Mean Absolute Error) to quantify the pixel-wise reconstruction, PSNR (Peak Signal to noise ratio), and SSIM (Structural Similarity Index) for pixel and perceptual similarity; LMD (Landmark Mean Distance) and AED (Average Euclidean Distance) to assess identity preservation; and FID (Frechet Inception Distance) to evaluate overall image quality, here we make use of 68 landmarks from dlib and not Mediapipe. L1, PSNR, SSIM, LMD, and AED are used only for same-ID reenactment where ground truth is available, while FID is applied in both settings.

For the Visual Face dubbing task, we use the LRS2 dataset. We sample 30 videos from the test set to evaluate the algorithms for face dubbing. We use the same metrics as Face Reenactment for the Visual Face Dubbing setting as well while adding Lip Sync Distance and Lip Sync Confidence Scores for evaluating lipsync. Here evaluations are performed in 2 settings: same audio dubbing and different audio dubbing. As the name suggests, in the same audio dubbing, we use the original video and dub it with the same audio. For different audio settings, we dub the video with different audio.

For the task of talking portraits, we use the LRS2 dataset. We sample 30 videos from the test set to evaluate metrics like FID, LSE-D, LSE-C, and AP. LSE-D and LSE-C are same as in dubbing task. AP is pose variance intensity. We conduct experiments with an image and an audio. Here, the Same ID audio essentially means the audio comes from the person in the source frame. In contrast, different ID audio means the audio comes from a different person, not the one in the source frame.

### Quantitative Evaluations

We will compare reconstruction, dubbing, and sync scores across different tasks.

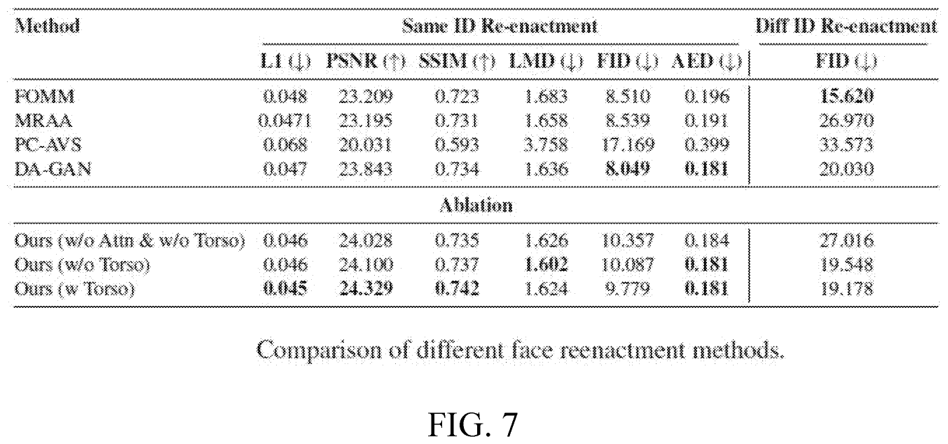

The quantitative evaluation results for face-reenactment are reported in FIG. 7. The method achieves the best performance in almost all visual quality metrics like L1, PSNR, and SSIM. The landmark distance LMD is much smaller than the other methods; this includes even the variants under the ablation study. This means that our facial landmarks are much more effectively reconstructed as intermediate representations as well. Our AED also confirms this fact. One thing to note here is that the landmark representations for evaluations are from dlib as taking Mediapipe would be skewed.

### Visual Face Dubbing

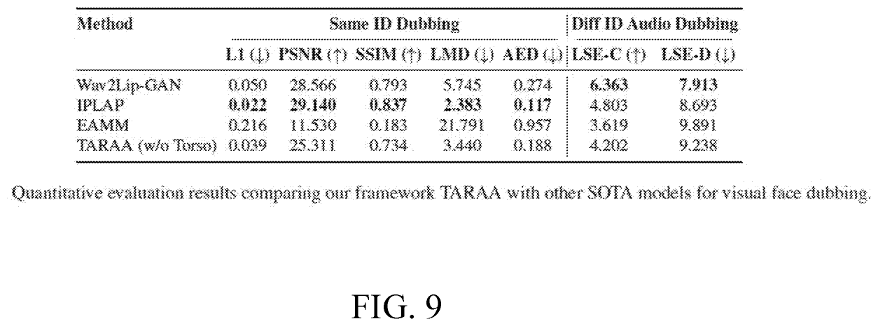

The quantitative evaluation results for visual face-dubbing tasks are reported in FIG. 9. Here we can see that our model results are very much consistent with respect to the scores we got from the face reenactment evaluation or even better as we just change the lip region here with predicted lips. The quality of reconstruction is at (0.39), which is the second-best next to IPLAP. We can also see that in almost all the tasks, the method performs competitively with Wav2Vec and IPLAP. Further human perceptual studies will give us more clarity on our position with respect to these models.

### Talking Portraits

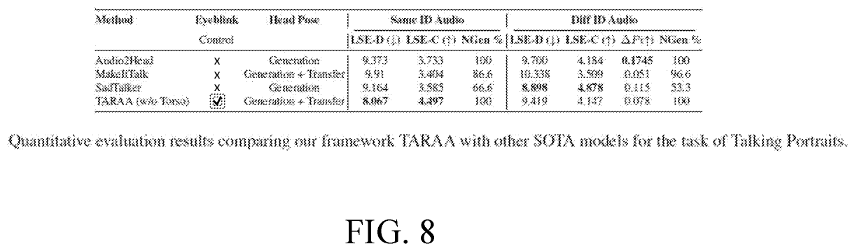

The results for the talking portraits task are given in FIG. 8. The model's sync score results in terms of the confidence LSE-C is way higher than the other models, and the LSE-D is the lowest of all. This essentially means the audio-visual sync is good, and the model that predicts this lip sync score is also confident about it.

### Qualitative Evaluation

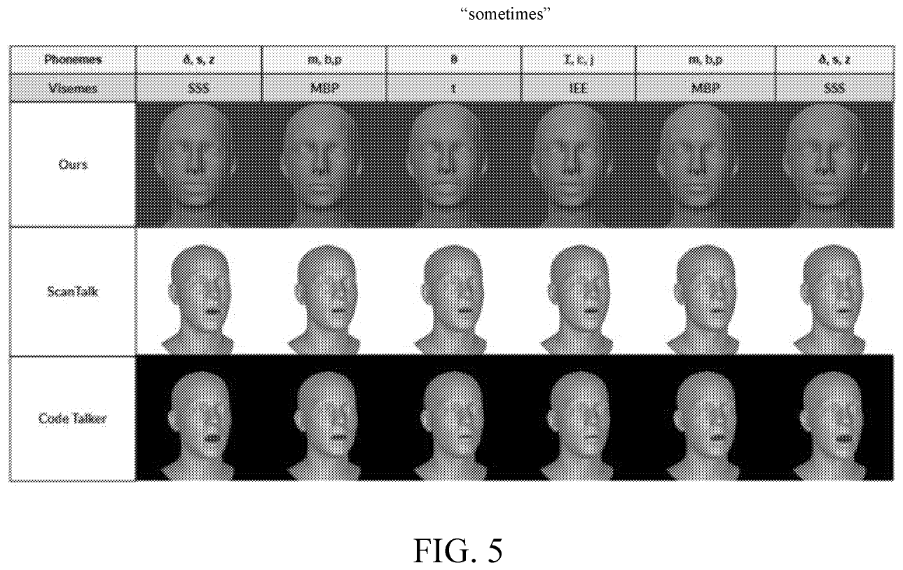

We lack ground truths for quantitative evaluation since we don't support 3D re-enactment. The qualitative comparison is shown in FIG. 5, which shows the spoken lip visemes across audio-driven 3D models. We see that our mappings are much better than the compared SOTAS. Here we have evaluated against SCANTALK and codetalker. We see that when we try to look at the lip movements for the word “sometimes” (FIG. 5), the model makes appropriate lip movements to properly pronounce the word, while SCANTALK just constantly keeps its mouth open, and Codetalker produces jaw movements with little to no co-articulation. The movement of the mouth is more pronounced in Codetalker, while the movements are very jittery in SCANTALK. The model also gives expressions like eyeblink control, while Codetalker or Scantalk don't provide the same. Our findings here in the Qualitative comparison are supported in our human perceptual evaluation.

### Perceptual User Study

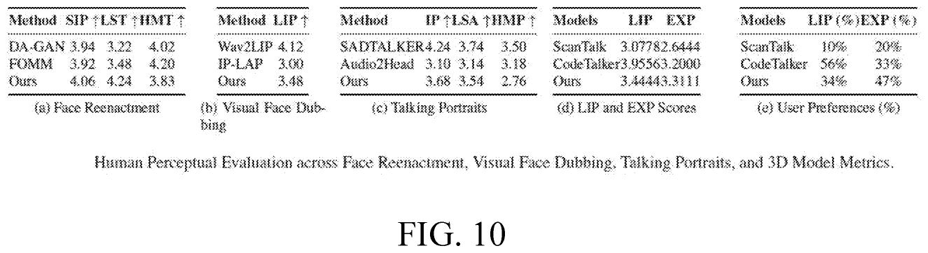

The Perceptual User Study results are shown in FIG. 10.

We conducted a human evaluation with 50 users across three 2D tasks-Face Reenactment, Visual Face Dubbing, and Talking Portraits-using 18 videos per task, rated from 1 to 5. In Face Reenactment, the model achieved the highest scores for Source Identity Preservation (SIP) (4.06) and Lip Sync Transfer (LST) (4.24), outperforming DA-GAN (3.94, 3.22) and FOMM (3.92, 3.48). Although our Head Motion Transfer (HMT) (3.83) was slightly lower than FOMM (4.20), it remained competitive. For Visual Face Dubbing, the model (3.48) performed well, surpassing IP-LAP (3.00), while Wav2LIP (4.12) led in Lip Sync Accuracy (LSA). This suggests the model is competitive despite IPLAP's higher quantitative results. In Talking Portraits, the model (3.68 Identity Preservation, 3.54 LSA) remained strong, competing with SADTALKER (4.24, 3.74) and outperforming Audio2Head (3.10, 3.14). The Head Motion Perception (HMP) (2.76) was lower due to a design choice of subtler, audio-driven head motions, unlike SADTALKER and Audio2Head, which produce more exaggerated movements. The approach excels in Face Reenactment and remains competitive across all tasks.

To evaluate the pipeline for 3D Talking Heads, we surveyed with 30 participants using 6 audio samples. The results of this are provided in FIG. 10. Participants first rated each model output on a 1-5 scale for Lip Sync Accuracy (LIP)—the alignment of lip movements to audio—and Expression Perception (EXP)—the congruence of generated expressions with the audio. They then compared outputs to indicate their overall preference for each metric. The method achieved a LIP score of 3.44 (second to CodeTalker's 3.96) and led in EXP with a score of 3.31 (versus CodeTalker's 3.20 and ScanTalk's 2.64). User preferences further supported these results, with the method favored by 34%.

### Ablation Study

In this section, we conduct ablation studies on our in-house collected dataset-Harvard-500 dataset, along with a subset of MSP-Face Dataset and evaluate the performance of Audio2Mesh Lip-Sync generation and Vox-Celeb to evaluate the Landmark image to natural image translation of the Mesh2pixel pipeline.

### Audio2Mesh: Choice of Recurrent Decoder

We train the model to predict a shorter sequence of 60 Frames and train it with a dataset of 2-3 hours at 60 FPS. Since the data is less and the sequences are also short, the LSTM model performs better than its Transformer counterpart.

### Mesh2Pixel: Effectiveness of Audio-Visual Attention

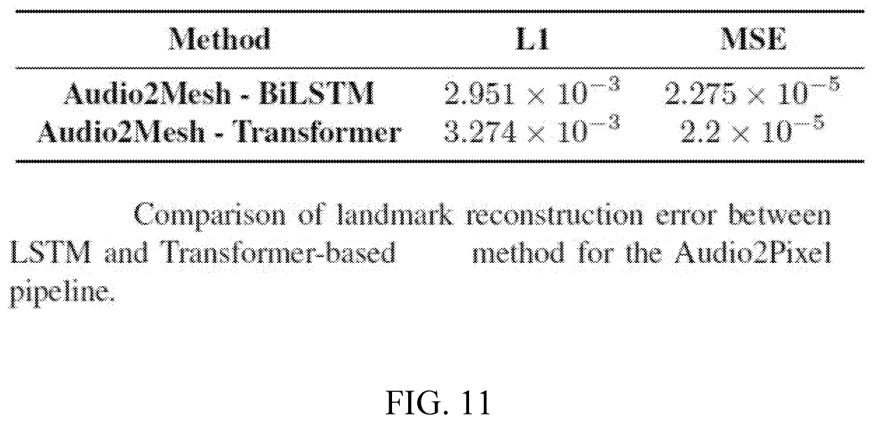

We attempt to remove the attention from the module and then pass the concatenation of the motion feature map and audio feature map into the identity-aware generator. The results for this can be seen in FIG. 11. We could see that the results of FID, which depicts the quality of generated images by comparing statistical properties of features extracted from real and generated images, explode compared to the variants with Attention. Moreover, all the metrics do not perform worse than the other models.

Mesh2Pixel: Landmark Sketch Design—with Torso Design Versus without Torso Design.

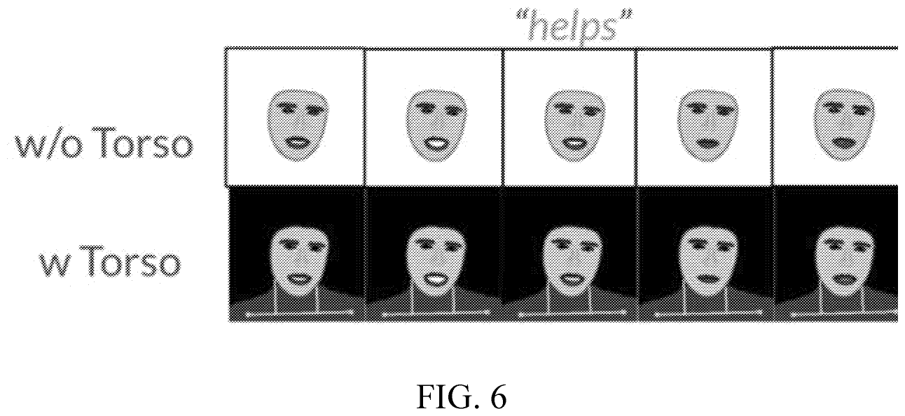

FIG. 6 is an image showing landmark sketches with and without torso, saying “helps” in accordance with embodiments of this disclosure. The figure shows the settings of with and without torso. The outputs for the model with Torso (in landmark sketches) seem to have the lip structure less expressive than the model without Torso. Meanwhile, the outputs from the Torso model are more stable regarding more natural movements. The results shown in FIG. 7 also suggest stability in the outputs, with the torso performing better (although a little) as against the no torso model. We use both of them interchangeably as and when required.

Described is TARAA, a unified architecture that is a realization-agnostic and 2D task-agnostic method for audio driven talking face generation. This is a two-stage architecture: the first stage, the Audio2Mesh pipeline, generates the landmark mesh given audio, and the second stage, the Mesh2Pixel pipeline, learns the mapping between landmark sketches and natural images. Extensive experiments and evaluations across different datasets show that our method is on par or even better in some cases across all the tasks and realization. Further, the current architecture works on a frame-by-frame basis, and a possible extension of the work would be to use a sequential decoder in the Mesh2Pixel pipeline to improve the temporal coherence of the generated expressions, and rotations could be realized even more realistically in the generated images.

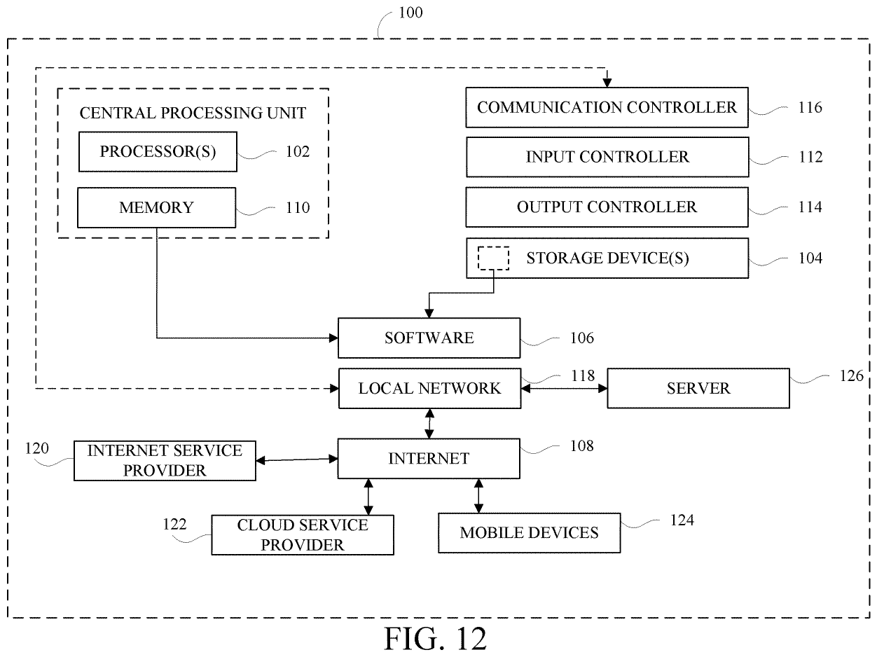

FIG. 12 is a block diagram of a system that comprises a computing device 100 to which the present disclosure may be applied according to an embodiment of the present disclosure. The system includes at least one processor (processor 102), designed to process instructions, for example computer readable instructions (i.e., code) stored on a storage device 104. By processing instructions, processor 102 may perform the steps and functions disclosed herein. Storage device 104 may be any type of storage device, for example, but not limited to an optical storage device, a magnetic storage device, a solid-state storage device, or a non-transitory storage device. The storage device 104 may contain software 106 which may include a set of instructions (i.e., code). Alternatively, instructions may be stored in one or more remote storage devices, for example storage devices accessed over a network or the internet 108. The computing device 100 also includes an operating system and microinstruction code. The various processes and functions described herein may either be part of the microinstruction code, part of the program, or a combination thereof, which is executed via the operating system. Computing device 100 additionally may have memory 110, an input controller 112, and an output controller 114 and communication controller 116. A bus (not shown) may operatively couple components of computing device 100, including processor 102, memory 110, storage device 104, input controller 112, output controller 114, and any other devices (e.g., network controllers, sound controllers, etc.). Output controller 114 may be operatively coupled (e.g., via a wired or wireless connection) to a display device such that output controller 114 is configured to transform the display on display device (e.g., in response to modules executed). Examples of a display device include, and are not limited to a monitor, television, mobile device screen, or touch-display. Input controller 112 may be operatively coupled via a wired or wireless connection to an input device such as a mouse, keyboard, touch pad, scanner, scroll-ball, or touch-display, for example. An input device (not shown) is configured to receive input from a user and transmit the received input to the computing device 100 vial the input controller 112. The input may be provided by the user through a multi-modal interface-based computer-implemented tool. These inputs are, but not limited to, images, speech, audio, text, facial expressions, body language, touch, scanned object, and video. The communication controller 116 is coupled to a bus (not shown) and provides a two-way coupling through a network link to the internet 108 that is connected to a local network 118 and operated by an internet service provider (ISP) (ISP 120) which provides data communication services to the internet 108. A network link may provide data communication through one or more networks to other data devices. For example, a network link may provide a connection through local network 118 to a host computer, to data equipment operated by the ISP 120. A cloud service provider 122 and mobile devices 124 provides data store and transfer services to other devices through internet 108. A server 126 may transmit a requested code for an application through internet 108, ISP 120, local network 118 and communication controller 116. FIG. 12 illustrates computing device 100 with all components as separate devices for ease of identification only. Each of the components shown in FIG. 12 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 100 may be implemented as one or more servers, for example a farm of networked servers, a clustered server environment, or a cloud network of computing devices.

Described herein a system for audio-driven facial animation that is task-agnostic and domain-agnostic which includes a processing pipeline including an audio-to-landmark generation module and a landmark-to-animation synthesis module, where the audio-to-landmark generation module and the landmark-to-animation synthesis module are decoupled to allow independent utilization of intermediate outputs for different animation tasks, the audio-to-landmark generation module is configured to receive an audio input and generate a sequence of facial landmarks that encode temporally coherent facial expressions, wherein the facial landmarks are independent of identity and adaptable to both 2D and 3D animation domains, the landmark-to-animation synthesis module is configured to generate animations for a target face from the generated facial landmarks, wherein the landmark-to-animation synthesis module supports both 2D and 3D representations by dynamically adapting to a target animation domain, a head pose adaptation mechanism configured to procedurally generate head movements from the audio input, or transfer head pose dynamics from a reference video, and a training architecture, wherein a single model is trained on a dataset to generate a trained model and wherein the trained model is reuseable across the different animation tasks without architectural modifications, where the processing pipeline enables editing of the generated facial expressions generated from the audio input in a landmark space.

In implementations, the facial landmarks are generated using a deep learning-based recurrent decoder model trained on a dataset of synchronized audio and facial motion data. In implementations, the facial landmark representation enables seamless blending between identity-specific and identity-independent expressions to maintain realism across the different animation tasks. In implementations, an identity and rotation adaptation module utilizes a recurrent neural network or transformer-based model to predict natural head movements based on speech intonation. In implementations, the generated animations are conditioned on user defined parameters such as speaking style intensity, eyeblink rate, or linguistic context. In implementations, the dataset includes synchronized audio and facial landmark data, curated for training and benchmarking the system. In implementations, the audio-to-landmark generation module is further configured to generate 3D facial landmarks from the audio input, enabling a unified representation that is compatible with both mesh-based 3D animation and image-based 2D animation. In implementations, the audio-to-landmark generation module further includes a speech content animation network that introduces variability in facial expressions based on speech content, ensuring that emotional and linguistic cues are reflected in the generated animations. In implementations, the system further includes an identity-head pose customization module, wherein the identity-head pose customization module is configured to condition lip-synced landmarks generated by the speech content animation network with integrating identity-specific facial structure and head pose adjustments, thereby ensuring identity preservation across different animation tasks. In implementations, the landmark-to-animation synthesis module is further configured to transform 3D landmark sequences into 2D identity-consistent, lip-synced talking-head videos, enabling seamless adaptation between 3D meshes and 2D image-based representations. In implementations, the landmark-to-animation synthesis module is further configured to apply face landmark and torso sketch images as driving conditions to generate animations on a 2D source image. In implementations, the landmark-to-animation synthesis module includes a motion estimation module, wherein the motion estimation module is configured to predict facial motion patterns from the audio input, source 2D images, and driving landmark images to ensure smooth and natural transitions between frames for temporally coherent animations. In implementations, the landmark-to-animation synthesis module includes an identity aware generator, wherein the identity aware generator is configured to process personalized facial motion patterns by conditioning animation synthesis on a reference identity image, ensuring consistency across different subjects while maintaining natural variability. In implementations, the identity-head pose customization module is further configured to employ stable first principles-based transformations to capture identity-specific facial deformations and pose adaptations, enabling personalized talking-head animations. In implementations, the landmark-to-animation synthesis module is optimized using adversarial training, where a discriminator network ensures that generated 2D talking-head videos maintain photorealistic quality and identity fidelity. In implementations, the dataset includes pose augmentation techniques to improve generalization across diverse camera angles. In implementations, the system further includes a 3D avatar module configured to create a rig of bones on a sculpted 3D mesh based on the generated facial landmarks from the landmark-to-animation synthesis module to animate a sculpted avatar. In implementations, the system further include a face reenactment pipeline configured to perform automated generation of rig bones to a 3D avatar to transfer expressions in 3D space.

Described herein is a method for generating task-agnostic and domain-agnostic audio-driven facial animations. The method includes generating a sequence of facial landmarks based on a received audio input, wherein the sequence of facial landmarks represent facial expressions independent of identity, and are compatible with both 2D and 3D animation workflows, synthesizing facial animations by mapping the sequence of facial landmarks onto a target face, wherein a facial animation is dynamically adaptable to a 2D image-based rendering or a 3D mesh-based rendering, applying a head pose adaptation strategy, wherein head pose information is either procedurally generated from speech patterns or extracted from a reference video, enabling cross-task generalization, wherein a same system architecture is used for face reenactment, visual dubbing, and talking portrait generation without requiring task-specific modifications, and facilitating domain adaptability, wherein a trained model can be used for both 2D and 3D facial animation without retraining or fine-tuning.

In implementations, the landmark-to-animation synthesis is trained for a face reenactment task and optimized for lip synchronization accuracy and expressive facial motion generation. In implementations, the facial animations are post-processed to enhance realism and temporal consistency. In implementations, a domain adaptation module enables cross-domain transfer by mapping 2D landmark motion sequences to 3D mesh-based deformations. In implementations, the method further includes modulating, by a speech content animation network, the facial animations by considering deep learning features extracted from the audio input, allowing natural expression variations beyond basic lip synchronization. In implementations, the method further includes capturing, by a convolution-based model in a motion estimation module, spatial motion information to predict future facial motion sequences, improving animation stability and realism. In implementations, the method further includes adaptively fusing, by a multi-modal attention mechanism, audio-driven motion features with identity-specific priors, ensuring both natural speech-driven movement and subject-specific expressiveness.

Described herein is a computer-readable storage medium storing instructions that, when executed by a processor, cause the processor to generate a sequence of facial landmarks based on a received audio input, wherein the sequence of facial landmarks represent facial expressions independent of identity, and are compatible with both 2D and 3D animation workflows, synthesize facial animations by mapping the sequence of facial landmarks onto a target face, wherein a facial animation is dynamically adaptable to a 2D image-based rendering or a 3D mesh-based rendering, apply a head pose adaptation strategy, wherein head pose information is either procedurally generated from speech patterns or extracted from a reference video, enable cross-task generalization, wherein a same system architecture is used for face reenactment, visual dubbing, and talking portrait generation without requiring task-specific modifications, and facilitate domain adaptability, wherein a trained model can be used for both 2D and 3D facial animation without retraining or fine-tuning.

In implementations, the landmark-to-animation synthesis is trained for face reenactment and optimized for lip synchronization accuracy and expressive facial motion generation. In implementations, the facial animations are post-processed to enhance realism and temporal consistency. In implementations, a domain adaptation module enables cross-domain transfer by mapping 2D landmark motion sequences to 3D mesh-based deformations. In implementations, execution of the instructions further causes the processor to modulate, by a speech content animation network, the facial animations by considering deep learning features extracted from the audio input, allowing natural expression variations beyond basic lip synchronization. In implementations, execution of the instructions further causes the processor to capture, by a convolution-based model in a motion estimation module, spatial motion information to predict future facial motion sequences, improving animation stability and realism. In implementations, execution of the instructions further causes the processor to adaptively fuse, by a multi-modal attention mechanism, audio-driven motion features with identity-specific priors, ensuring both natural speech-driven movement and subject-specific expressiveness.

Described herein is a computer-implemented method for generating task-agnostic and domain-agnostic audio-driven facial animations. The computer-implemented method includes generating a sequence of facial landmarks based on a received audio input, wherein the sequence of facial landmarks represent facial expressions independent of identity, and are compatible with both 2D and 3D animation workflows, synthesizing facial animations by mapping the sequence of facial landmarks onto a target face, wherein a facial animation is dynamically adaptable to a 2D image-based rendering or a 3D mesh-based rendering, applying a head pose adaptation strategy, wherein head pose information is either procedurally generated from speech patterns or extracted from a reference video, enabling cross-task generalization, wherein a same system architecture is used for face reenactment, visual dubbing, and talking portrait generation without requiring task-specific modifications, and facilitating domain adaptability, wherein a trained model can be used for both 2D and 3D facial animation without retraining or fine-tuning.

In implementations, landmark-to-animation synthesis is trained for face reenactment and optimized for lip synchronization accuracy and expressive facial motion generation. In implementations, the facial animations are post-processed to enhance realism and temporal consistency. In implementations, a domain adaptation module enables cross-domain transfer by mapping 2D landmark motion sequences to 3D mesh-based deformations. In implementations, the computer-implemented method further includes modulating, by a speech content animation network, the facial animations by considering deep learning features extracted from the audio input, allowing natural expression variations beyond basic lip synchronization. In implementations, the computer-implemented method further includes capturing, by a convolution-based model in a motion estimation module, spatial motion information to predict future facial motion sequences, improving animation stability and realism. In implementations, the computer-implemented method further includes adaptively fusing, by a multi-modal attention mechanism, audio-driven motion features with identity-specific priors, ensuring both natural speech-driven movement and subject-specific expressiveness.

While the embodiments described herein may be susceptible to various modifications and alternative forms, specific embodiments thereof are shown by way of example in the drawings and will be described in detail below. It should be understood, however that these examples not intended to limit the embodiments to the particular forms disclosed, but on the contrary, the disclosed embodiments cover all modifications, equivalents, and alternatives falling within the spirit and the scope of the disclosure as defined by the appended claims.

The method steps have been represented, wherever appropriate, by conventional symbols in the drawings, showing those specific details that are pertinent to understanding the embodiments so as not to obscure the disclosure with details that will be readily apparent to those of ordinary skill in the art having benefit of the description herein.

The terms “comprises,” “comprising,” or any other variations thereof, are intended to cover a non-exclusive inclusion, such that a process, method that comprises a list of steps does not include only those steps but may include other steps not expressly listed or inherent to such process or method. Similarly, one or more elements in a system or apparatus proceeded by “comprises . . . a” does not, without more constraints, preclude the existence of other elements or additional elements in the system or apparatus.

The features of the present embodiments are set forth with particularity in the appended claims. Each embodiment itself, together with further features and attended advantages, will become apparent from consideration of the following detailed description, taken in conjunction with the accompanying drawings.

The disclosed embodiments describe retrieving and organizing information from a set of applications, data sources, or both, by performing various steps as is described in details in forthcoming sections. For the sake explanation and understanding, reference is drawn towards a typical search query where the process heavily relies on multi-modality technology for converging speech, text, images, touch, language, and the like. Success of such a multi-modality platform mainly depends on how good and relevant the obtained results are.

Having described and illustrated the principles with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein.

Elements of the described embodiments shown in software may be implemented in hardware and vice versa. As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine-readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory. Modules can be defined by executable code stored on non-transient media.

The following description is presented to enable a person of ordinary skill in the art to make and use the embodiments and is provided in the context of the requirement for a obtaining a patent. The present description is the best presently-contemplated method for carrying out the present embodiments. Various modifications to the embodiments will be readily apparent to those skilled in the art and the generic principles of the present embodiments may be applied to other embodiments, and some features of the present embodiments may be used without the corresponding use of other features. Accordingly, the present embodiments are not intended to be limited to the embodiments shown but are to be accorded the widest scope consistent with the principles and features described herein.

The contents of each of the following are herein incorporated by reference as if set forth herein in their entireties.
Madhav Agarwal, Rudrabha Mukhopadhyay, Vinay P. Namboodiri, and C. V. Jawahar. Audio-visual face reenactment. In Proceedings of the IEEE/CVF Winter Conference on Applications of Computer Vision (WACV), pages 5178-5187, 2023.
Alexei Baevski, Yuhao Zhou, Abdelrahman Mohamed, and Michael Auli. wav2vec 2.0: A framework for self-supervised learning of speech representations. Advances in neural information processing systems, 33:12449-12460, 2020.
V. Blanz and T. Vetter. A morphable model for the synthesis of 3d faces. In Proceedings of the 26th Annual Conference on Computer Graphics and Interactive Techniques (SIGGRAPH), pages 187-194, 1999.
Stella Bounareli, Vasileios Argyriou, and Georgios Tzimiropoulos. Finding directions in gan's latent space for neural face reenactment. arXiv preprint arXiv: 2202.00046, 2022.
Stella Bounareli, Christos Tzelepis, Vasileios Argyriou, Ioannis Patras, and Georgios Tzimiropoulos. Hyperreenact: one-shot reenactment via jointly learning to refine and retarget faces. In Proceedings of the IEEE/CVF International Conference on Computer Vision, pages 7149-7159, 2023.
Stella Bounareli, Christos Tzelepis, Vasileios Argyriou, Ioannis Patras, and Georgios Tzimiropoulos. Diffusionact: Controllable diffusion autoencoder for one-shot face reenactment. arXiv preprint arXiv: 2403. 17217, 2024.
Lele Chen, Ross Maddox, Zhiyao Duan, and Chenliang Xu. Hierarchical cross-modal talking face generation with dynamic pixel-wise loss. 2019.
Lele Chen, Ross K Maddox, Zhiyao Duan, and Chenliang Xu. Hierarchical cross-modal talking face generation with dynamic pixel-wise loss. In Proceedings of the IEEE/CVF conference on computer vision and pattern recognition, pages 7832-7841, 2019.
Byungkuk Choi, Haekwang Eom, Benjamin Mouscadet, Stephen Cullingford, Kurt Ma, Stefanie Gassel, Suzi Kim, Andrew Moffat, Millicent Maier, Marco Revelant, et al. Animatomy: An animator-centric, anatomically inspired system for 3d facial modeling, animation and transfer. In SIGGRAPH Asia 2022 conference papers, pages 1-9, 2022.
J. S. Chung and A. Zisserman. Out of time: automated lip sync in the wild. In Workshop on Multi-view Lip-reading, ACCV, 2016.
J. S. Chung, A. Senior, O. Vinyals, and A. Zisserman. Lip reading sentences in the wild. In IEEE Conference on Computer Vision and Pattern Recognition, 2017.
Daniel Cudeiro, Timo Bolkart, Cassidy Laidlaw, Anurag Ranjan, and Michael J Black. Capture, learning, and synthesis of 3d speaking styles. In Proceedings of the IEEE/CVF conference on computer vision and pattern recognition, pages 10101-10111, 2019.
Radek Dane ̌cek, Michael J Black, and Timo Bolkart. Emoca: ̌Emotion driven monocular face capture and animation. In Proceedings of the IEEE/CVF Conference on Computer Vision and Pattern Recognition, pages 20311-20322, 2022.
Michail Christos Doukas, Evangelos Ververas, Viktoriia Sharmanska, and Stefanos Zafeiriou. Free-headgan: Neural talking head synthesis with explicit gaze control. IEEE Transactions on Pattern Analysis and Machine Intelligence, 45 (8): 9743-9756, 2023.
Nikita Drobyshev, Jenya Chelishev, Taras Khakhulin, Aleksei Ivakhnenko, Victor Lempitsky, and Egor Zakharov. Megaportraits: One-shot megapixel neural head avatars. In Proceedings of the 30th ACM International Conference on Multimedia, pages 2663-2671, 2022.
Nikita Drobyshev, Antoni Bigata Casademunt, Konstantinos Vougioukas, Zoe Landgraf, Stavros Petridis, and Maja Pantic. Emoportraits: Emotion-enhanced multimodal one-shot head avatars. In Proceedings of the IEEE/CVF Conference on Computer Vision and Pattern Recognition, pages 8498-8507, 2024.
Chenpeng Du, Qi Chen, Tianyu He, Xu Tan, Xie Chen, Kai Yu, Sheng Zhao, and Jiang Bian. Dae-talker: High fidelity speech-driven talking face generation with diffusion autoencoder. In Proceedings of the 31st ACM International Conference on Multimedia, pages 4281-4289, 2023.
Yao Feng, Haiwen Feng, Michael J Black, and Timo Bolkart. Learning an animatable detailed 3d face model from in-thewild images. ACM Transactions on Graphics (ToG), 40 (4): 1-13, 2021.
Ian Goodfellow, Jean Pouget-Abadie, Mehdi Mirza, Bing Xu, David Warde-Farley, Sherjil Ozair, Aaron Courville, and Yoshua Bengio. Generative adversarial networks. Communications of the ACM, 63 (11): 139-144, 2020.
Yudong Guo, Keyu Chen, Sen Liang, Yong-Jin Liu, Hujun Bao, and Juyong Zhang. Ad-nerf: Audio driven neural radiance fields for talking head synthesis. In Proceedings of the IEEE/CVF international conference on computer vision, pages 5784-5794, 2021.
Sungjoo Ha, Martin Kersner, Beomsu Kim, Seokjun Seo, and Dongyoung Kim. Marionette: Few-shot face reenactment preserving identity of unseen targets. In AAAI Conference on Artificial Intelligence, 2019.
Sungjoo Ha, Martin Kersner, Beomsu Kim, Seokjun Seo, and Dongyoung Kim. Marionette: Few-shot face reenactment preserving identity of unseen targets. In Proceedings of the AAAI conference on artificial intelligence, pages 10893-10900, 2020.
Tianyu He, Junliang Guo, Runyi Yu, Yuchi Wang, Jialiang Zhu, Kaikai An, Leyi Li, Xu Tan, Chunyu Wang, Han Hu, et al. Gaia: Zero-shot talking avatar generation. ar Xiv preprint arXiv: 2311.15230, 2023.
Sepp Hochreiter and Jurgen Schmidhuber. Long short-term” memory. Neural computation, 9 (8): 1735-1780, 1997.
Fa-Ting Hong and Dan Xu. Implicit identity representation conditioned memory compensation network for talking head video generation. In Proceedings of the IEEE/CVF International Conference on Computer Vision (ICCV), pages 23062-23072, 2023.
Fa-Ting Hong, Longhao Zhang, Li Shen, and Dan Xu. Depth-aware generative adversarial network for talking head video generation. In Proceedings of the IEEE/CVF conference on computer vision and pattern recognition, pages 3397-3406, 2022.
Yang Hong, Bo Peng, Haiyao Xiao, Ligang Liu, and Juyong Zhang. Headnerf: A real-time nerf-based parametric head model. In Proceedings of the IEEE/CVF Conference on Computer Vision and Pattern Recognition (CVPR), pages 20374-20384, 2022.
Yang Hong, Bo Peng, Haiyao Xiao, Ligang Liu, and Juyong Zhang. Headnerf: A real-time nerf-based parametric head model. In IEEE/CVF Conference on Computer Vision and Pattern Recognition (CVPR), 2022.
Xinya Ji, Hang Zhou, Kaisiyuan Wang, Qianyi Wu, Wayne Wu, Feng Xu, and Xun Cao. Eamm: One-shot emotional talking face via audio-based emotion-aware motion model. In ACM SIGGRAPH 2022 Conference Proceedings, New York, NY, USA, 2022. Association for Computing Machinery.
Taras Khakhulin, Vanessa Sklyarova, Victor Lempitsky, and Egor Zakharov. Realistic one-shot mesh-based head avatars. In European Conference on Computer Vision, pages 345-362. Springer, 2022.
Diederik P Kingma, Max Welling, et al. Auto-encoding variational bayes, 2013.
Tobias Kirschstein, Simon Giebenhain, and Matthias Nießner. Diffusionavatars: Deferred diffusion for highfidelity 3d head avatars. In Proceedings of the IEEE/CVF Conference on Computer Vision and Pattern Recognition, pages 5481-5492, 2024.
Jiahe Li, Jiawei Zhang, Xiao Bai, Jun Zhou, and Lin Gu. Efficient region-aware neural radiance fields for high-fidelity talking portrait synthesis. In Proceedings of the IEEE/CVF International Conference on Computer Vision (ICCV), pages 7568-7578, 2023.
Jiahe Li, Jiawei Zhang, Xiao Bai, Jin Zheng, Jun Zhou, and Lin Gu. Er-nerf++: Efficient region-aware neural radiance fields for high-fidelity talking portrait synthesis. Information Fusion, 110:102456, 2024.
Tianye Li, Timo Bolkart, Michael. J. Black, Hao Li, and Javier Romero. Learning a model of facial shape and expression from 4D scans. ACM Transactions on Graphics, (Proc. SIGGRAPH Asia), 36 (6): 194:1-194:17, 2017.
Tianye Li, Timo Bolkart, Michael J Black, Hao Li, and Javier Romero. Learning a model of facial shape and expression from 4d scans. ACM Trans. Graph., 36 (6): 194-1, 2017.
Weichuang Li, Longhao Zhang, Dong Wang, Bin Zhao, Zhigang Wang, Mulin Chen, Bang Zhang, Zhongjian Wang, Liefeng Bo, and Xuelong Li. One-shot high-fidelity talkinghead synthesis with deformable neural radiance field. In Proceedings of the IEEE/CVF Conference on Computer Vision and Pattern Recognition (CVPR), pages 17969-17978, 2023.
Xueting Li, Shalini De Mello, Sifei Liu, Koki Nagano, Umar Iqbal, and Jan Kautz. Generalizable one-shot 3d neural head avatar. Advances in Neural Information Processing Systems, 36:47239-47250, 2023.
Yihong Lin, Zhaoxin Fan, Xianjia Wu, Lingyu Xiong, Liang Peng, Xiandong Li, Wenxiong Kang, Songju Lei, and Huang Xu. Glditalker: Speech-driven 3d facial animation with graph latent diffusion transformer. ar Xiv preprint ar Xiv: 2408.01826, 2024.
Jin Liu, Xi Wang, Xiaomeng Fu, Yesheng Chai, Cai Yu, Jiao Dai, and Jizhong Han. Font: Flow-guided one-shot talking head generation with natural head motions. 2023 IEEE International Conference on Multimedia and Expo (ICME), pages 2099-2104, 2023.
Pengfei Liu, Wenjin Deng, Hengda Li, Jintai Wang, Yinglin Zheng, Yiwei Ding, Xiaohu Guo, and Ming Zeng. Musicface: Music-driven expressive singing face synthesis. Computational Visual Media, 10:119-136, 2023.
Tao Liu, Chenpeng Du, Shuai Fan, Feilong Chen, and Kai Yu. Diffdub: Person-generic visual dubbing using inpainting renderer with diffusion auto-encoder. In ICASSP 20242024 IEEE International Conference on Acoustics, Speech and Signal Processing (ICASSP), pages 3630-3634. IEEE, 2024.
Yunfei Liu, Lijian Lin, Fei Yu, Changyin Zhou, and Yu Li. Moda: Mapping-once audio-driven portrait animation with dual attentions. In Proceedings of the IEEE/CVF International Conference on Computer Vision (ICCV), pages 23020-23029, 2023.
Camillo Lugaresi, Jiuqiang Tang, Hadon Nash, Chris McClanahan, Esha Uboweja, Michael Hays, Fan Zhang, ChuoLing Chang, Ming Guang Yong, Juhyun Lee, et al. Mediapipe: A framework for building perception pipelines. arXiv preprint ar Xiv: 1906.08172, 2019.
Arun Mallya, Ting-Chun Wang, and Ming-Yu Liu. Implicit Warping for Animation with Image Sets. In NeurIPS, 2022.
Moustafa Meshry, Saksham Suri, Larry S Davis, and Abhinav Shrivastava. Learned spatial representations for fewshot talking-head synthesis. In Proceedings of the IEEE/CVF international conference on computer vision, pages 13829-13838, 2021.
Soumik Mukhopadhyay, Saksham Suri, Ravi Teja Gadde, and Abhinav Shrivastava. Diff2lip: Audio conditioned diffusion models for lip-synchronization. In Proceedings of the IEEE/CVF Winter Conference on Applications of Computer Vision (WACV), pages 5292-5302, 2024.
A. Nagrani, J. S. Chung, and A. Zisserman. Voxceleb: a large-scale speaker identification dataset. In INTERSPEECH, 2017.
Haomiao Ni, Yihao Liu, Sharon X Huang, and Yuan Xue. Cross-identity video motion retargeting with joint transformation and synthesis. In Proceedings of the IEEE/CVF winter conference on applications of computer vision, pages 412-422, 2023.
F. Nocentini, T. Besnier, C. Ferrari, S. Arguillere, S. Berretti, and M. Daoudi. Scantalk: 3d talking heads from unregistered scans. In Proceedings of the European Conference on Computer Vision (ECCV), 2024.
Trevine Oorloff and Yaser Yacoob. Expressive talking head video encoding in stylegan2 latent space. In Proceedings of the IEEE/CVF International Conference on Computer Vision (ICCV) Workshops, pages 2998-3007, 2023.
Yifang Pan, Rishabh Agrawal, and Karan Singh. S3: Speech, script and scene driven head and eye animation. ACM Transactions on Graphics (TOG), 43 (4): 1-12, 2024.
K R Prajwal, Rudrabha Mukhopadhyay, Vinay P. Namboodiri, and C.V. Jawahar. A lip sync expert is all you need for speech to lip generation in the wild. In Proceedings of the 28th ACM International Conference on Multimedia, page 484-492, New York, NY, USA, 2020. Association for Computing Machinery.
Di Qiu, Zheng Chen, Rui Wang, Mingyuan Fan, Changqian Yu, Junshi Huang, and Xiang Wen. Moviecharacter: A tuning-free framework for controllable character video synthesis. ar Xiv preprint arXiv: 2410.20974, 2024.
Olaf Ronneberger, Philipp Fischer, and Thomas Brox. Unet: Convolutional networks for biomedical image segmentation. In Medical image computing and computer-assisted intervention—MICCAI 2015: 18th international conference, Munich, Germany, Oct. 5-9, 2015, proceedings, part III, 18, pages 234-241. Springer, 2015.
Steffen Schneider, Alexei Baevski, Ronan Collobert, and Michael Auli. wav2vec: Unsupervised pre-training for speech recognition. ar Xiv preprint ar Xiv: 1904.05862, 2019.
Shuai Shen, Wanhua Li, Xiaoke Huang, Zheng Zhu, Jie Zhou, and Jiwen Lu. Sd-nerf: Towards lifelike talking head animation via spatially-adaptive dual-driven nerfs. IEEE Transactions on Multimedia, 26:3221-3234, 2023.
Kumar Shubham, Laxmi Narayen Nagarajan Venkatesan, Dinesh Babu Jayagopi, and Raj Tumuluri. Multimodal embodied conversational agents: A discussion of architectures, frameworks and modules for commercial applications. In 2022 IEEE International Conference on Artificial Intelligence and Virtual Reality (AIVR), pages 36-45. IEEE, 2022.
Aliaksandr Siarohin, Stephane Lathuili’ ere, Sergey Tulyakov, Elisa Ricci, and Nicu Sebe. First order motion model for image animation. Advances in neural information processing systems, 32, 2019.
Aliaksandr Siarohin, Oliver J. Woodford, Jian Ren, Menglei Chai, and Sergey Tulyakov. Motion representations for articulated animation. In Proceedings of the IEEE/CVF Conference on Computer Vision and Pattern Recognition (CVPR), pages 13653-13662, 2021.
Yu Ding Changjie Fan Xin Yu0 Suzhen Wang, Lincheng Li. Audio2head: Audio-driven one-shot talking-head generation with natural head motion. In the 30th International Joint Conference on Artificial Intelligence (IJCAI-21), 2021.
Jintao Tan, Xize Cheng, Lingyu Xiong, Lei Zhu, Xiandong Li, Xianjia Wu, Kai Gong, Minglei Li, and Yi Cai. Landmark-guided diffusion model for high-fidelity and temporally coherent talking head generation. In 2024 IEEE International Conference on Multimedia and Expo (ICME), pages 1-6. IEEE, 2024.
Shuai Tan, Bin Ji, and Ye Pan. Emmn: Emotional motion memory network for audio-driven emotional talking face generation. In 2023 IEEE/CVF International Conference on Computer Vision (ICCV), pages 22089-22099, 2023.
Jiaxiang Tang, Kaisiyuan Wang, Hang Zhou, Xiaokang Chen, Dongliang He, Tianshu Hu, Jingtuo Liu, Gang Zeng, and Jingdong Wang. Real-time neural radiance talking portrait synthesis via audio-spatial decomposition. arXiv preprint ar Xiv: 2211.12368, 2022.
Soumya Tripathy, Juho Kannala, and Esa Rahtu. Facegan: Facial attribute controllable reenactment gan. In Proceedings of the IEEE/CVF Winter Conference on Applications of Computer Vision (WACV), pages 1329-1338, 2021.
Ashish Vaswani, Noam Shazeer, Niki Parmar, Jakob Uszkoreit, Llion Jones, Aidan N Gomez, Łukasz Kaiser, and Illia Polosukhin. Attention is all you need. Advances in neural information processing systems, 30, 2017.
Andrea Vidal, Ali Salman, Wei-Cheng Lin, and Carlos Busso. Msp-face corpus: a natural audiovisual emotional database. In Proceedings of the 2020 international conference on multimodal interaction, pages 397-405, 2020.
Konstantinos Vougioukas, Stavros Petridis, and Maja Pantic. Realistic speech-driven facial animation with gans. Int. J. Comput. Vision, 128 (5): 1398-1413, 2020.
Qiulin Wang, Lu Zhang, and Bo Li. Safa: Structure aware face animation. In 2021 International Conference on 3D Vision (3DV), pages 679-688. IEEE, 2021.
Ting-Chun Wang, Arun Mallya, and Ming-Yu Liu. One-shot free-view neural talking-head synthesis for video conferencing. In Proceedings of the IEEE/CVF conference on computer vision and pattern recognition, pages 10039-10049, 2021.
Xintao Wang, Ke Yu, Shixiang Wu, Jinjin Gu, Yihao Liu, Chao Dong, Yu Qiao, and Chen Change Loy. Esrgan: Enhanced super-resolution generative adversarial networks. In Proceedings of the European conference on computer vision (ECCV) workshops, pages 0-0, 2018.
Xintao Wang, Yu Li, Honglun Zhang, and Ying Shan. Towards real-world blind face restoration with generative facial prior. In The IEEE Conference on Computer Vision and Pattern Recognition (CVPR), 2021.
Yaohui Wang, Di Yang, Francois Bremond, and Antitza Dantcheva. Latent image animator: Learning to animate images via latent space navigation. In International Conference on Learning Representations, 2022.
Wayne Wu, Yunxuan Zhang, Cheng Li, Chen Qian, and Chen Change Loy. Reenactgan: Learning to reenact faces via boundary transfer. In Proceedings of the European conference on computer vision (ECCV), pages 603-619, 2018.
Jinbo Xing, Menghan Xia, Yuechen Zhang, Xiaodong Cun, Jue Wang, and Tien-Tsin Wong. Codetalker: Speech-driven 3d facial animation with discrete motion prior. In Proceedings of the IEEE/CVF Conference on Computer Vision and Pattern Recognition, pages 12780-12790, 2023.
Sicheng Xu, Guojun Chen, Yu-Xiao Guo, Jiaolong Yang, Chong Li, Zhenyu Zang, Yizhong Zhang, Xin Tong, and Baining Guo. Vasa-1: Lifelike audio-driven talking faces generated in real time. Advances in Neural Information Processing Systems, 37:660-684, 2025.
Guangming Yao, Yi Yuan, Tianjia Shao, and Kun Zhou. Mesh guided one-shot face reenactment using graph convolutional networks. In Proceedings of the 28th ACM international conference on multimedia, pages 1773-1781, 2020.
Shunyu Yao, RuiZhe Zhong, Yichao Yan, Guangtao Zhai, and Xiaokang Yang. Dfa-nerf: Personalized talking head generation via disentangled face attributes neural rendering, 2022.
Zhenhui Ye, Ziyue Jiang, Yi Ren, Jinglin Liu, Chen Zhang, Xiang Yin, Zejun Ma, and Zhou Zhao. Ada-tta: Towards adaptive high-quality text-to-talking avatar synthesis. ar Xiv preprint ar Xiv: 2306.03504, 2023.
Hongyun Yu, Zhan Qu, Qihang Yu, Jianchuan Chen, Zhonghua Jiang, Zhiwen Chen, Shengyu Zhang, Jimin Xu, Fei Wu, Chengfei Lv, et al. Gaussiantalker: Speaker-specific talking head synthesis via 3d gaussian splatting. In Proceedings of the 32nd ACM International Conference on Multimedia, pages 3548-3557, 2024.
Egor Zakharov, Aleksei Ivakhnenko, Aliaksandra Shysheya, and Victor Lempitsky. Fast bi-layer neural synthesis of oneshot realistic head avatars. In Computer Vision—ECCV 2020: 16th European Conference, Glasgow, UK, Aug. 23-28, 2020, Proceedings, Part XII, page 524-540, Berlin, Heidelberg, 2020. Springer-Verlag.
Egor Zakharov, Aleksei Ivakhnenko, Aliaksandra Shysheya, and Victor Lempitsky. Fast bi-layer neural synthesis of oneshot realistic head avatars. In Computer Vision—ECCV 2020: 16th European Conference, Glasgow, UK, Aug. 23-28, 2020, Proceedings, Part XII 16, pages 524-540. Springer, 2020.
Bowen Zhang, Chenyang Qi, Pan Zhang, Bo Zhang, HsiangTao Wu, Dong Chen, Qifeng Chen, Yong Wang, and Fang Wen. Metaportrait: Identity-preserving talking head generation with fast personalized adaptation. In Proceedings of the IEEE/CVF Conference on Computer Vision and Pattern Recognition (CVPR), pages 22096-22105, 2023.
Chenxu Zhang, Yifan Zhao, Yifei Huang, Ming Zeng, Saifeng Ni, Madhukar Budagavi, and Xiaohu Guo. Facial: Synthesizing dynamic talking face with implicit attribute learning. In Proceedings of the IEEE/CVF International Conference on Computer Vision (ICCV), pages 3867-3876, 2021.
Juan Zhang, Jiahao Chen, Cheng Wang, Zhiwang Yu, Tangquan Qi, Can Liu, and Di Wu. Virbo: Multimodal multilingual avatar video generation in digital marketing. arXiv preprint ar Xiv: 2403.11700, 2024.
Jian Zhao and Hui Zhang. Thin-plate spline motion model for image animation. In Proceedings of the IEEE/CVF Conference on Computer Vision and Pattern Recognition, pages 3657-3666, 2022.
Qingcheng Zhao, Pengyu Long, Qixuan Zhang, Dafei Qin, Han Liang, Longwen Zhang, Yingliang Zhang, Jingyi Yu, and Lan Xu. Media2face: Co-speech facial animation generation with multi-modality guidance. In ACM SIGGRAPH 2024 conference papers, pages 1-13, 2024.
Zhongyuan Zhao, Zhenyu Bao, Qing Li, Guoping Qiu, and Kanglin Liu. Psavatar: A point-based shape model for realtime head avatar animation with 3d gaussian splatting. 2024.
Weizhi Zhong, Chaowei Fang, Yinqi Cai, Pengxu Wei, Gangming Zhao, Liang Lin, and Guanbin Li. Identitypreserving talking face generation with landmark and appearance priors. In Proceedings of the IEEE/CVF Conference on Computer Vision and Pattern Recognition (CVPR), pages 9729-9738, 2023.
Hang Zhou, Yasheng Sun, Wayne Wu, Chen Change Loy, Xiaogang Wang, and Ziwei Liu. Pose-controllable talking face generation by implicitly modularized audio-visual representation. In Proceedings of the IEEE Conference on Computer Vision and Pattern Recognition (CVPR), 2021.
Yang Zhou, Xintong Han, Eli Shechtman, Jose Echevarria, Evangelos Kalogerakis, and Dingzeyu Li. Makelttalk: speaker-aware talking-head animation. ACM Trans. Graph., 39 (6), 2020.

What is claimed is:

1. A system for audio-driven facial animation that is task-agnostic and domain-agnostic, comprising:
a processing pipeline including an audio-to-landmark generation module and a landmark-to-animation synthesis module, where the audio-to-landmark generation module and the landmark-to-animation synthesis module are decoupled to allow independent utilization of intermediate outputs for different animation tasks;
the audio-to-landmark generation module is configured to receive an audio input and generate a sequence of facial landmarks that encode temporally coherent facial expressions, wherein the facial landmarks are independent of identity and adaptable to both 2D and 3D animation domains;
the landmark-to-animation synthesis module is configured to generate animations for a target face from the generated facial landmarks, wherein the landmark-to-animation synthesis module supports both 2D and 3D representations by dynamically adapting to a target animation domain;
a head pose adaptation mechanism configured to procedurally generate head movements from the audio input, or transfer head pose dynamics from a reference video; and
a training architecture, wherein a single model is trained on a dataset to generate a trained model and wherein the trained model is reuseable across the different animation tasks without architectural modifications,
wherein the processing pipeline enables editing of the generated facial expressions generated from the audio input in a landmark space.

2. The system of claim 1, wherein the facial landmarks are generated using a deep learning-based recurrent decoder model trained on a dataset of synchronized audio and facial motion data.

3. The system of claim 1, wherein the facial landmark representation enables seamless blending between identity-specific and identity-independent expressions to maintain realism across the different animation tasks.

4. The system of claim 1, wherein an identity and rotation adaptation module utilizes a recurrent neural network or transformer-based model to predict natural head movements based on speech intonation.

5. The system of claim 1, wherein the generated animations are conditioned on user defined parameters such as speaking style intensity, eyeblink rate, or linguistic context.

6. The system of claim 1, wherein the dataset includes synchronized audio and facial landmark data, curated for training and benchmarking the system.

7. The system of claim 1, wherein the audio-to-landmark generation module is further configured to:
generate 3D facial landmarks from the audio input, enabling a unified representation that is compatible with both mesh-based 3D animation and image-based 2D animation.

8. The system of claim 1, where the audio-to-landmark generation module further includes a speech content animation network that introduces variability in facial expressions based on speech content, ensuring that emotional and linguistic cues are reflected in the generated animations.

9. The system of claim 8, wherein the system further comprises an identity-head pose customization module, wherein the identity-head pose customization module is configured to:
condition lip-synced landmarks generated by the speech content animation network with integrating identity-specific facial structure and head pose adjustments, thereby ensuring identity preservation across different animation tasks.

10. The system of claim 1, wherein the landmark-to-animation synthesis module is further configured to:
transform 3D landmark sequences into 2D identity-consistent, lip-synced talking-head videos, enabling seamless adaptation between 3D meshes and 2D image-based representations.

11. The system of claim 1, wherein the landmark-to-animation synthesis module is further configured to:
apply face landmark and torso sketch images as driving conditions to generate animations on a 2D source image.

12. The system of claim 1, wherein the landmark-to-animation synthesis module includes a motion estimation module, wherein the motion estimation module is configured to:
predict facial motion patterns from the audio input, source 2D images, and driving landmark images to ensure smooth and natural transitions between frames for temporally coherent animations.

13. The system of claim 12, wherein the landmark-to-animation synthesis module includes an identity aware generator, wherein the identity aware generator is configured to:
process personalized facial motion patterns by conditioning animation synthesis on a reference identity image, ensuring consistency across different subjects while maintaining natural variability.

14. The system of claim 9, wherein the identity-head pose customization module is further configured to:
employ stable first principles-based transformations to capture identity-specific facial deformations and pose adaptations, enabling personalized talking-head animations.

15. The system of claim 1, wherein the landmark-to-animation synthesis module is optimized using adversarial training, where a discriminator network ensures that generated 2D talking-head videos maintain photorealistic quality and identity fidelity.

16. The system of claim 6, wherein the dataset includes pose augmentation techniques to improve generalization across diverse camera angles.

17. The system of claim 1, wherein the system further comprises a 3D avatar module configured to:
create a rig of bones on a sculpted 3D mesh based on the generated facial landmarks from the landmark-to-animation synthesis module to animate a sculpted avatar.

18. The system of claim 1, wherein the system further comprises a face reenactment pipeline configured to:
perform automated generation of rig bones to a 3D avatar to transfer expressions in 3D space.

19. A method for generating task-agnostic and domain-agnostic audio-driven facial animations, comprising:
generating a sequence of facial landmarks based on a received audio input, wherein the sequence of facial landmarks represent facial expressions independent of identity, and are compatible with both 2D and 3D animation workflows;
synthesizing facial animations by mapping the sequence of facial landmarks onto a target face, wherein a facial animation is dynamically adaptable to a 2D image-based rendering or a 3D mesh-based rendering;
applying a head pose adaptation strategy, wherein head pose information is either procedurally generated from speech patterns or extracted from a reference video;
enabling cross-task generalization, wherein a same system architecture is used for face reenactment, visual dubbing, and talking portrait generation without requiring task-specific modifications; and
facilitating domain adaptability, wherein a trained model can be used for both 2D and 3D facial animation without retraining or fine-tuning.

20. The method of claim 19, wherein landmark-to-animation synthesis is trained for a face reenactment task and optimized for lip synchronization accuracy and expressive facial motion generation.

21. The method of claim 19, wherein the facial animations are post-processed to enhance realism and temporal consistency.

22. The method of claim 19, wherein a domain adaptation module enables cross-domain transfer by mapping 2D landmark motion sequences to 3D mesh-based deformations.

23. The method of claim 19, further comprises:
modulating, by a speech content animation network, the facial animations by considering deep learning features extracted from the audio input, allowing natural expression variations beyond basic lip synchronization.

24. The method of claim 19, further comprises:
capturing, by a convolution-based model in a motion estimation module, spatial motion information to predict future facial motion sequences, improving animation stability and realism.

25. The method of claim 19, further comprises:
adaptively fusing, by a multi-modal attention mechanism, audio-driven motion features with identity-specific priors, ensuring both natural speech-driven movement and subject-specific expressiveness.

26. A computer-readable storage medium storing instructions that, when executed by a processor, cause the processor to:
generate a sequence of facial landmarks based on a received audio input, wherein the sequence of facial landmarks represent facial expressions independent of identity, and are compatible with both 2D and 3D animation workflows;
synthesize facial animations by mapping the sequence of facial landmarks onto a target face, wherein a facial animation is dynamically adaptable to a 2D image-based rendering or a 3D mesh-based rendering;
apply a head pose adaptation strategy, wherein head pose information is either procedurally generated from speech patterns or extracted from a reference video;
enable cross-task generalization, wherein a same system architecture is used for face reenactment, visual dubbing, and talking portrait generation without requiring task-specific modifications; and
facilitate domain adaptability, wherein a trained model can be used for both 2D and 3D facial animation without retraining or fine-tuning.

27. The computer-readable storage medium of claim 26, wherein landmark-to-animation synthesis is trained for face reenactment and optimized for lip synchronization accuracy and expressive facial motion generation.

28. The computer-readable storage medium of claim 26, wherein the facial animations are post-processed to enhance realism and temporal consistency.

29. The computer-readable storage medium of claim 26, wherein a domain adaptation module enables cross-domain transfer by mapping 2D landmark motion sequences to 3D mesh-based deformations.

30. The computer-readable storage medium of claim 26, wherein execution of the instructions further causes the processor to:
modulate, by a speech content animation network, the facial animations by considering deep learning features extracted from the audio input, allowing natural expression variations beyond basic lip synchronization.

31. The computer-readable storage medium of claim 26, wherein execution of the instructions further causes the processor to:
capture, by a convolution-based model in a motion estimation module, spatial motion information to predict future facial motion sequences, improving animation stability and realism.

32. The computer-readable storage medium of claim 26, wherein execution of the instructions further causes the processor to:
adaptively fuse, by a multi-modal attention mechanism, audio-driven motion features with identity-specific priors, ensuring both natural speech-driven movement and subject-specific expressiveness.

33. A computer-implemented method for generating task-agnostic and domain-agnostic audio-driven facial animations, comprising:
generating a sequence of facial landmarks based on a received audio input, wherein the sequence of facial landmarks represent facial expressions independent of identity, and are compatible with both 2D and 3D animation workflows;
synthesizing facial animations by mapping the sequence of facial landmarks onto a target face, wherein a facial animation is dynamically adaptable to a 2D image-based rendering or a 3D mesh-based rendering;
applying a head pose adaptation strategy, wherein head pose information is either procedurally generated from speech patterns or extracted from a reference video;
enabling cross-task generalization, wherein a same system architecture is used for face reenactment, visual dubbing, and talking portrait generation without requiring task-specific modifications; and
facilitating domain adaptability, wherein a trained model can be used for both 2D and 3D facial animation without retraining or fine-tuning.

34. The computer-implemented method of claim 33, wherein landmark-to-animation synthesis is trained for face reenactment and optimized for lip synchronization accuracy and expressive facial motion generation.

35. The computer-implemented method of claim 33, wherein the facial animations are post-processed to enhance realism and temporal consistency.

36. The computer-implemented method of claim 33, wherein a domain adaptation module enables cross-domain transfer by mapping 2D landmark motion sequences to 3D mesh-based deformations.

37. The computer-implemented method of claim 33, wherein the computer-implemented method further comprises:
modulating, by a speech content animation network, the facial animations by considering deep learning features extracted from the audio input, allowing natural expression variations beyond basic lip synchronization.

38. The computer-implemented method of claim 33, wherein the computer-implemented method further comprises:
capturing, by a convolution-based model in a motion estimation module, spatial motion information to predict future facial motion sequences, improving animation stability and realism.

39. The computer-implemented method of claim 33, wherein the computer-implemented method further comprises:
adaptively fusing, by a multi-modal attention mechanism, audio-driven motion features with identity-specific priors, ensuring both natural speech-driven movement and subject-specific expressiveness.
